(19) United States
(12) Patent Application Publication
(10) Pub. No.: US 2011/0071952 A1
(43) Pub. Date: Mar. 24, 2011

(54) SYSTEM AND METHOD OF OPTIMIZING RESOURCE CONSUMPTION

(76) Inventors: Michael P. Gaffney, Norfolk, VA (US); Peter J. Ryan, Chesapeake, VA (US); Matthew W. McKeon, Norfolk, VA (US)

(21) Appl. No.: 12/562,793

(22) Filed: Sep. 18, 2009

(51) Int. Cl. G06Q 50/00; G06Q 10/00

(52) U.S. Cl. 705/317

(57) ABSTRACT

A system and method for quantifying and optimizing resource consumption and waste generation of a plurality of resource consumer devices that consume one or more consumable resources to produce useful work. The system and method comprise an input module that receives input data related to each of the plurality of resource consumer devices and each of the one or more consumable resources, a resource consumer module that determines an amount of the one or more consumable resource consumed by each of the plurality of resource consumer devices under a particular load and an amount of waste produced by each of the plurality of resource consumer devices under the particular load based at least in part on the input data, a waste stream module that normalizes and sums the amount of waste produced by each of the plurality of resource consumer devices per amount of useful work produced, and an output module that determines costs associated with operating the plurality of resource consumer devices based at least in part on the amount of the one or more consumable resource consumed by each of the plurality of resource consumer devices and the normalized and summed amount of waste produced by each of the plurality of resource consumer devices.

### FIELD OF THE INVENTION

The present invention relates to a system and method of quantifying optimizing resource consumption within a system. More particularly, the present invention relates to a system and method of analyzing various resources, devices, and useful work produced by those resources and devices to determine appropriate energy conservation measures for optimizing resource consumption.

### BACKGROUND OF THE INVENTION

The rising costs of natural resources and growing concern with resource waste has led to the development of energy efficiency software for performing statistical analyses for resource management. That software either analyzes specific pieces of equipment within a system for individual efficiency with no relation to the overall system or analyzes energy consumption on a macro level across an entire system looking only for consumption anomalies within the system. For example, that software typically inputs utility data (e.g., electrical meter readings, heating oil delivery receipts, rate structure, delivery contract details, etc.) and other data (e.g., degree days, EPA reported utility carbon emissions, etc.), categorizes usage by items (e.g., building service, location, type of rate plan, etc.), and then analyzes the input data for statistical outliers (e.g., higher than average electrical charges in the month of June for one building within a group of ten similar buildings). But, by performing their analysis on a system level (e.g., an entire building) or an equipment level without relation to the overall system (e.g., looking at an air conditioner in isolation), that software fails to maximize both overall system efficiency and the efficiency of individual pieces of equipment based on each piece of equipment's relation to the overall system. Accordingly, there is a need for a system and method of optimizing resource consumption that performs its analysis on a subsystem level (e.g., heating, ventilation, air conditioning, building lighting, computer power, safety systems, etc.) and an equipment level (e.g., heaters, compressors, generators, etc.) and takes a comprehensive system approach by quantifying the interdependent factors affecting the power consumption costs and overall system efficiency associated with each piece of equipment in a system.

In addition, one factor that known energy efficiency software fails to consider in performing its analysis is cost and efficiency data for the maintenance and repair of subsystems and equipment. Thus, that software is unable provide a life cycle cost comparison between repair or replace options for certain subsystems and equipment, which, as the present invention demonstrates, can further help a user of such software make decisions to improve overall system efficiency. Accordingly, there is also a need for a system and method of optimizing resource consumption that factors in cost and efficiency data for the maintenance and repair of subsystems and equipment.

And, although some known energy efficiency software factors in waste stream data when performing statistical analyses for resource management, such waste stream data is typically limited to some type of carbon emissions. That software, however, does not factor in other types of waste streams (e.g., nitrogen (NOx) sulfur (SOx), particular mater, carbon monoxide, used oil, oily slops, used fluorescent light bulbs, waste chemicals etc.), which, as the present invention demonstrates, can be used to provide a more accurate assessment of the true “cost” of using certain resources. Accordingly, there is also a need for a system and method of optimizing resource consumption that factors in more than just carbon emissions.

### SUMMARY OF THE INVENTION

Accordingly, to solve at least the problems and/or disadvantages described above, and to provide at least the advantages described below, a non-limiting object of the present invention is to provide a system and method for quantifying and optimizing resource consumption and waste generation of a plurality of resource consumer devices that consume one or more consumable resources to produce useful work. The system and method comprise an input module that receives input data related to each of the plurality of resource consumer devices and each of the one or more consumable resources, a resource consumer module that determines an amount of the one or more consumable resource consumed by each of the plurality of resource consumer devices under a particular load and an amount of waste produced by each of the plurality of resource consumer devices under the particular load based at least in part on the input data, a waste stream module that normalizes and sums the amount of waste produced by each of the plurality of resource consumer devices per amount of useful work produced, and an output module that determines costs associated with operating the plurality of resource consumer devices based at least in part on the amount of the one or more consumable resource consumed by each of the plurality of resource consumer devices and the normalized and summed amount of waste produced by each of the plurality of resource consumer devices. Those and other objects of the invention, as well as many of the intended advantages thereof, will become more readily apparent when reference is made to the following description, taken in conjunction with the accompanying drawings.

### BRIEF DESCRIPTION OF THE DRAWINGS

FIG. 1 is a schematic diagram illustrating a plurality of integrated modules for optimizing resource consumption according to a non-limiting embodiment of the present invention;

FIGS. 2A-2H illustrate an exemplary database structure for the present invention.

FIG. 3 is a schematic diagram illustrating the flow of data between the integrated modules of FIG. 1;

FIG. 4 is a schematic diagram illustrating exemplary data inputs for the input module of FIG. 1;

FIG. 5 is a schematic diagram illustrating exemplary data inputs for an input module for a vessel;

FIG. 6 is a schematic diagram illustrating exemplary resource converter sub-modules within a resource converter module for a vessel;

FIG. 7 is a schematic diagram illustrating exemplary data inputs, data outputs, and calculations that occur at a diesel generator sub-module within the resource conversion module of FIG. 1;

FIG. 8 illustrates an exemplary integral table generated by the present invention showing the results of an evaluation of electric motors in a system based on a system user's financial criteria;

FIG. 9 is a schematic diagram illustrating exemplary data inputs, data outputs, and calculations that occur at an electrical resource consumer sub-module within the resource consumer module of FIG. 1;

FIG. 10 is a schematic diagram illustrating exemplary data inputs, data outputs, and calculations that occur at an ice storage system sub-module within the resource storage module of FIG. 1;

FIGS. 11A-11D illustrate exemplary integral tables generated by the present invention showing the results of an evaluation of in-port and at-sea thermal load on devices on a vessel that produce thermal energy;

FIG. 12 is a schematic diagram illustrating exemplary data inputs, data outputs, and calculations that occur at a thermal energy sub-module within the waste stream module of FIG. 1;

FIG. 13 is a schematic diagram illustrating exemplary output sub-modules within the output module of FIG. 1;

FIG. 14 is an exemplary integral table generated by the present invention showing the various savings that will result from implementing energy conservation measures on several pieces of equipment on a vessel;

FIG. 15 is an exemplary integral table generated by the present invention showing the emissions savings that will result from implementing energy conservation measures on several pieces of equipment on a vessel;

FIG. 16 is an exemplary integral table generated by the present invention showing the results of a financial analysis of an energy conservation measure; and

FIG. 17 illustrates a graph generated by the present invention plotting the results of the normalized resource consumption based on vessel speed in accordance with the analysis illustrated in FIG. 16.

### DETAILED DESCRIPTION OF THE EXEMPLARY EMBODIMENTS

The present invention provides a system and method of measuring the amount of resources consumed to produce useful work, the cost and efficiency of that resource consumption, the cost and efficiency of converting resources for consumption, waste generation, and the cost by per unit efficiency at each level of consumption from a micro to a macro level. Based on such measurements, the present invention proposes various energy conservation measures (ECMs), such as improvements in operating profiles, equipment modifications, and other changes that will improve equipment and system efficiencies. Among the factors considered in making those proposed ECMs are resource supply costs, resource consumption costs, equipment efficiencies, system efficiencies, returns on investments based on equipment costs, maintenance cost comparisons between equipment, and incentives available for resource consumption reduction initiatives. The present achieves those ends by separating resource consumption into three constituent components—conversion, supply, and consumption—and analyzing each of those components to determine the optimal per unit efficiency (i.e., the amount of resource consumed per amount of useful work produced from that resource) in view of the per unit waste (e.g., the amount of waste produced per amount of useful work produced) for each resource over a specified period of time.

The conversion component includes convertible resources (e.g., diesel fuel) that need to have their potential energy converted into a consumable resource (e.g., electricity or mechanical work) using a resource converter (e.g., a diesel generator). In addition to converting convertible resources into a consumable form with a resource converter (e.g. a diesel generator), resources may also be provided already in their consumable form from a resource supplier (e.g., a power company). The supply component includes the supply of convertible resources to resource converters (e.g., a diesel generator) and consumable resources to resource consumers (e.g., a light bulb or an electric engine). And, the consumption component includes the consumption of consumable resources by resource consumers to produce useful work (e.g., lighting a room for an hour) and the waste (e.g., emissions from the diesel generator and thermal energy from the light bulb) associated with that consumption.

Each component of each resource is analyzed in terms of consumption, waste, and useful work and the costs associated therewith. Consumption is the measurable rate at which the resource is consumed (e.g., diesel fuel=gallons/hour (g/h) and electricity=kilowatt-hours (kW-h)). Waste is the measurable amount of bi-products produced from consumption of resources (e.g., diesel fuel=exhaust gas emissions (CO₂)+thermal energy and electricity=thermal energy losses (i²r)), either by resource converters (e.g., diesel generators) or resource consumers (e.g., light bulbs). And, useful work is the measurable amount of the desired result produced by resource consumption (e.g., kW-h associated with lighting a room for an hour or amount of heat energy removed from air by an air conditioner). By analyzing consumption, waste, and useful work in measurable amounts, a cost (i.e., a financial unit) can be associated with each of those items (e.g., consumption: diesel fuel=$/g and/or electricity=$/kW-h; waste: disposal=$/lb. and/or carbon credit=$/lb.; useful work: lighting=$/day and/or movement=$/mile).

By analyzing the consumption, waste, and useful work for each component of each resource and the various costs associated therewith, the present invention can propose various ECMs that will optimize the operation of a system holistically. For example, the present invention may identify combinations of resources, resource converters, resource consumers, and/or resource storage devices that produce the desired amount of useful work for the least overall cost by consuming less resources through the recapture of useful waste energy from resource consumers and/or resource converters. Or, the present invention may identify different times that certain resources should be consumed or equipment modifications that may be made to improve overall system efficiency. Accordingly, the present invention finds significant utility in its ability to quantify the interrelationship between resource conversion, consumption, waste, and useful work and to identify the most cost effective and environmentally sound modes of operation within a system based on that quantification.

For example, the existing characteristics of the resources, resource converters, resource consumers, and/or resource storage devices of a given system are considered that system's baseline. After the baseline is established, it is used to estimate the system's current energy consumption, waste, and cost. A user can then create “hypothetical” models where a hierarchy of resources, resource converters, resource consumers, and/or resource storage devices within the system are either added to, modified, or removed in order to model various ECMs against each the system's baseline. Each hypothetical model can be saved as the new baseline for the system. The following steps could be used to create and save a new baseline: (1) define and name system by type; (2) build system hierarchy by collecting baseline data on-site; (3) run basic energy consumption models against the system's baseline; (4) create a series of hypothetical models for comparison with the system's current baseline; (5) run comparisons between the baseline and the hypothetical models; and (6) make the most attractive hypothetical model the new baseline.

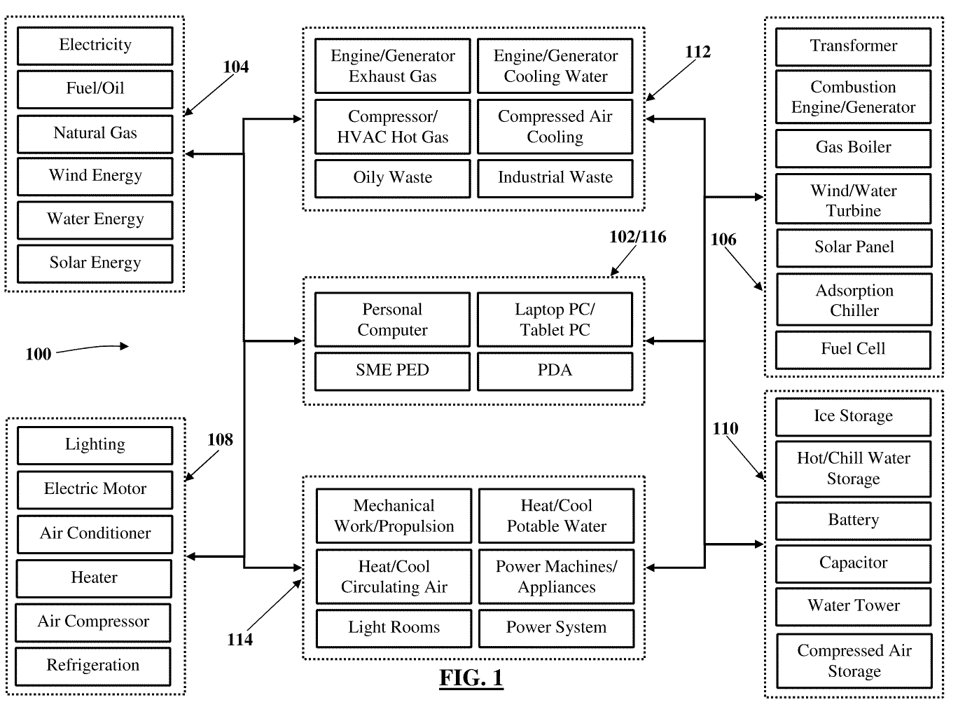

Reference will now be made in detail to non-limiting embodiments of the present invention by way of reference to the accompanying drawings, wherein like reference numerals refer to like parts, components, and structures. Turning to the drawings, FIG. 1 illustrates a non-limiting exemplary embodiment of a modular system 100 according to the present invention. The modular system 100 includes an input module 102, a resource supply module 104, a resource converter module 106, a resource consumer module 108, a resource storage module 110, a waste stream module 112, a useful work module 114, and an output module 116. Each of those modules 102-116 can be used to analyze one or more resource, device, waste stream, or amount of useful work. Because substantially the same devices are associated with the input module 102 and output module 116, those modules are illustrated as a single module in FIG. 1. In practice, those modules are preferably separate.

As FIG. 1 illustrates, the input module 102 and output module 116 are configured to interact with various user interface devices (e.g., a Personal Computer (PC), a laptop PC, a Tablet PC, a Secure Mobile Environment Portable Electronic Device (SME PED), and a Personal Digital Assistant (PDA)); the resource suppler module 104 is configured to analyze various resources (e.g., electricity, fuel and oil, natural gas, wind energy, water energy, and solar energy); the resource converter module 106 is configured to analyze various resource converters (e.g., electrical transformers, combustion-type electrical generators, combustion engines, gas boilers, water and/or wind turbines, solar panels, and an adsorption chillers, fuel cells); the resource consumer module 108 is configured to analyze various types of resource consumers (e.g., light bulbs, electric motors, air conditioners (HVAC), heaters, air compressors, and refrigeration devices); the resource storage module 110 is configured to analyze various resource storage devices (e.g., an ice storage device, hot and chill water storage devices, batteries, capacitors, water towers, and compressed air storage); the waste stream module 112 is configured to analyze various waste streams (e.g., thermal energy from engine and/or generator exhaust, thermal energy from engine and/or generator cooling water, thermal energy from air compressor or HVAC condenser hot gas condensation, thermal energy from compressed air cooling, emissions, noise, vibration, used oil, oily waste, and industrial waste); and the useful work module 114 is configured to analyze various forms of useful work (e.g., mechanical work and/or propulsion (turning a crank shaft), heating and/or cooling potable water, heating or cooling circulating air, powering machines and/or appliances, lighting rooms, and powering the system 100 or other systems). Just as any of the modules 102-116 may be added or removed from the present invention as required to suit a particular system, the present invention also integrates the various resources, devices, waste streams, and useful work as sub-modules of each of their respective modules so as to allow them also to be added or removed from those modules 102-116 as required to suit that particular system. Moreover, each resource, device, waste stream, or useful work of a similar type within a particular module can be grouped together in the same sub-module. Accordingly, the present invention provides functionality that facilitates integration and easy scaling for use with systems of substantially any size.

For example, the resources, resource converters, resource consumers, and/or resource storage devices of a given system can be broken down into a hierarchy of sub-systems within each system, including, for example, lighting equipment, motors, pumps, compressors, etc. After each system's hierarchy is built, each system and subsystem can be combined with other systems and subsystems to form assemblies. Those assemblies can be formed on a fractal basis with an ever-increasing number of systems and subsystems being combined (e.g., an air conditioner may be one piece of equipment in an HVAC sub-system, the HVAC sub-system may be part a system defined by a building, the building may be part of a complex defined by series of buildings, the buildings may be part of a city or a division of a corporation, the city be may be part of a region or the division may be part of a larger corporation, etc.), which provides substantial flexibility when defining the scope of the analysis performed by the present invention. Accordingly, the present invention allows ECMs to be modeled across sub-systems, systems, entire corporations, or even entire geographic regions.

As FIG. 1 also illustrates, all of the modules 102-116 are integrated with each other to facilitate seamless bi-directional communication between each of the modules 102-116. The modules 102-116 may be embodied on a computer readable medium that can be executed by one or more processors provided on one or more central servers (not shown). The processor(s) manages data flow between each of the modules 102-116 according to the present invention using a known architecture, such as a three-tier architecture. The processor(s) also controls data storage and retrieval in at least one relational database using a known system language, such as the Structured Query Language (SQL). The relational database is configured to provide persistent data storage for current and historical input data.

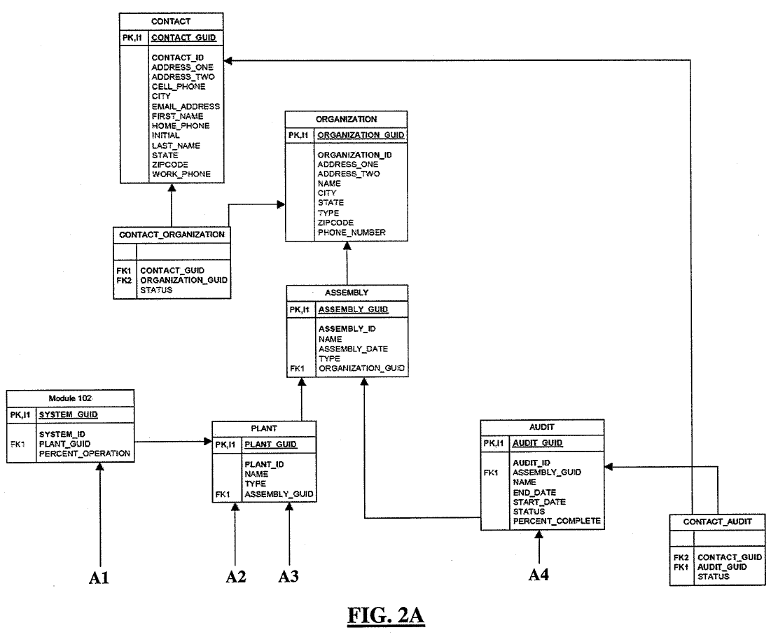

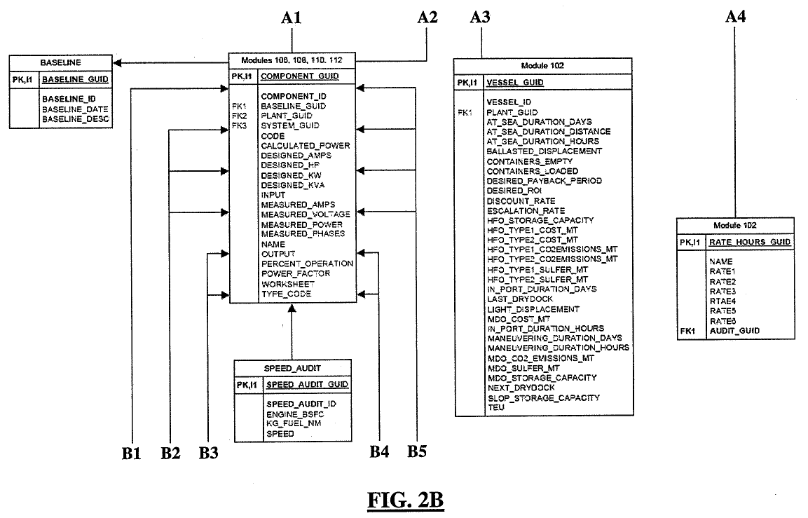

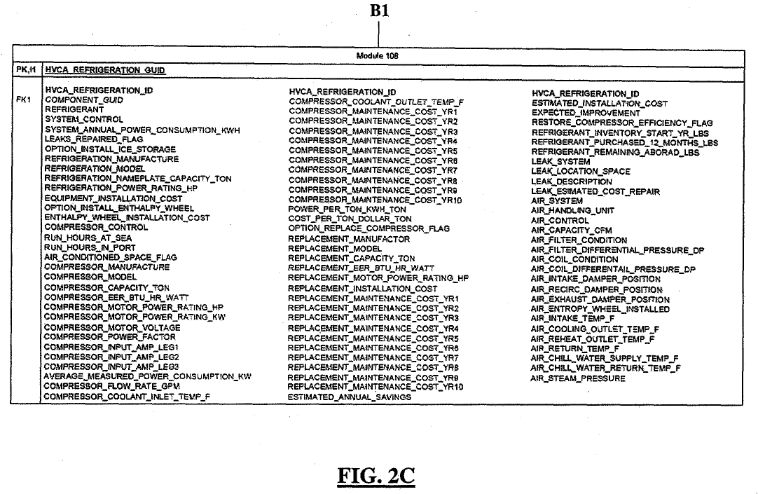

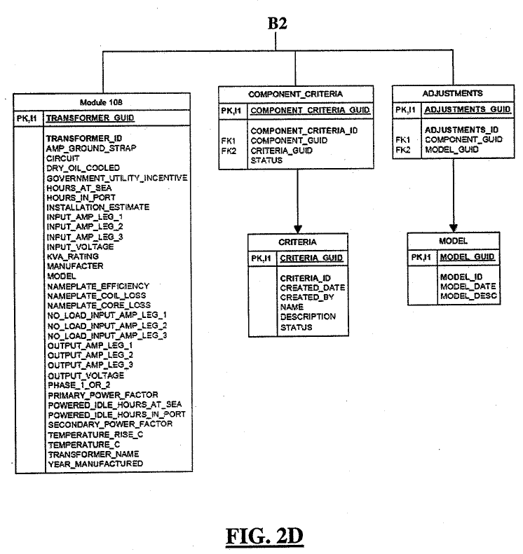

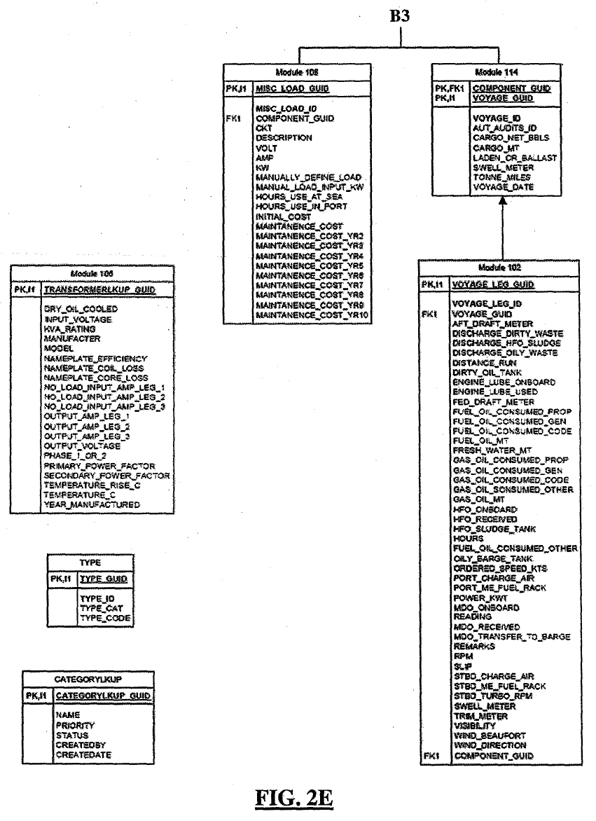

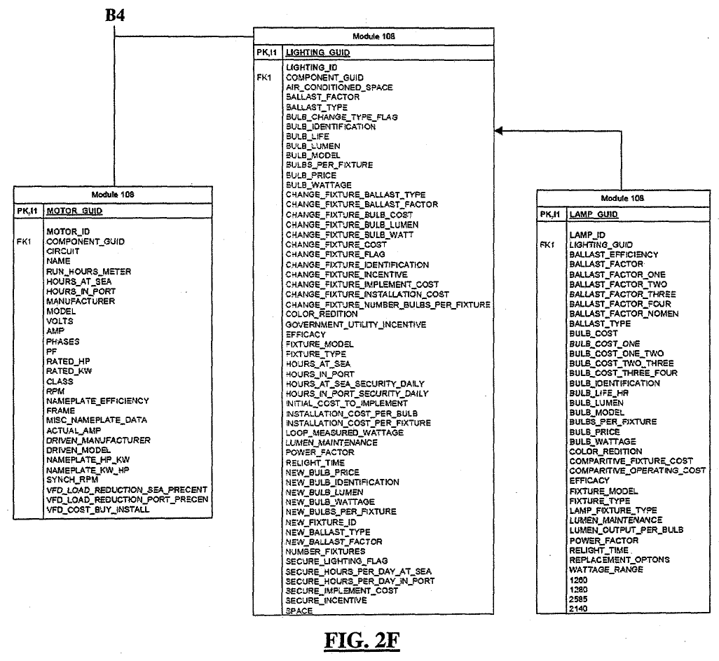

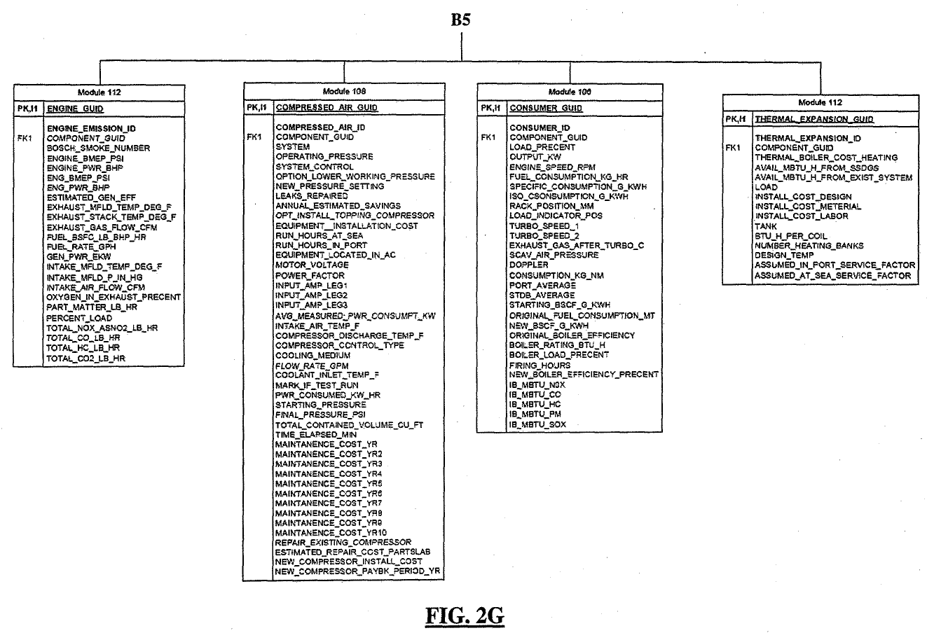

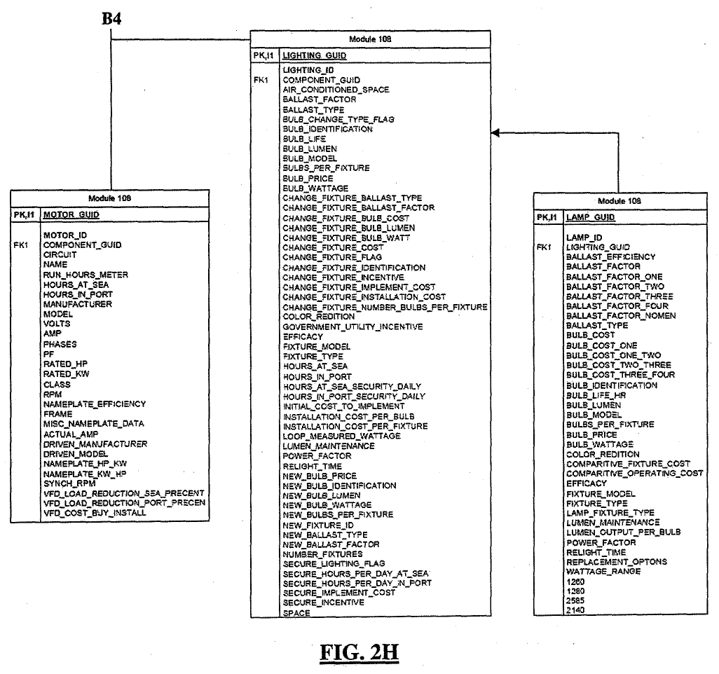

The database persists/stores data such as contacts, organizations, audits, rates, voyage data, assemblies, plants, systems, equipment, and all equipment details. The equipment details include details about consumers (e.g., miscellaneous loads, motors, lighting, HVAC refrigeration, lamps, compressed air, etc.), converters (e.g., generators, transformers, etc.), waste streams (e.g., engine emission, thermal expansion, etc.), useful work (e.g., voyage data, project life cycle, etc.), and associated attachments (e.g., pictures, images, documents, etc.). Accordingly, the present invention not only facilitates seamless bi-directional communication between each of the modules 102-116, it also provides a structured database system for efficient data storage and retrieval by and through those modules 102-116. FIGS. 2A-2H illustrate exemplary data storage and retrieval for the modules 102-116 in a system comprising a vessel (e.g., a ship, barge, tug, crane, etc.). Both the modules 102-116 of the current invention and the database of the current invention can be embodied on a suitable data storage device (e.g., RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information).

In a preferred embodiment of the present invention, the modules 102-116 perform their analysis based on data gathered using auditing software and user inputs at the input module 102. But, in addition integrating the various modules 102-116 with each other on the central server(s), the central server(s) may also be connected directly to the various resources, devices, waste streams, and amounts of useful work analyzed by those modules 102-116 via a computer network, such as a Wide Area Network (WAN) or Local Area Network (LAN), using a broadband connection, such as a Digital Subscriber Line (DSL), cable modem, wireless link, or other high-speed connection. Thus, in an alternative embodiment, the modules 102-116 may also actively monitor and/or control the various resources, devices, waste streams, and amounts of useful work of the system 100, in real time, via those connections.

In the embodiment wherein the modules 102-116 of the present invention are also used to monitor the various resources, devices, waste streams, and useful work, the modules 102-116 may be connected to each of the various resources, devices, waste streams, and useful work over a computer network and each of those resources, devices, waste streams, and useful work can be interconnected to one another over the computer network so the system 100 can be monitored in a holistic manner. For example, the input module 102 may interact with the programmable microprocessor on the server(s) to remotely activate an electric generator in the resource converter module 106 by transmitting a communication (e.g., an electronic or transduced control signal) over the network to engage the electric generator's electric starter using a known technique, such as direct digital control (DDC). The output module 116 can then measure the volume of fuel (e.g., gallons per hour (g/h)) flowing from the resource module 104 to the electric generator by receiving a communication from an electronic flow meter and can measure the amount of electricity (e.g., Kilowatts (kW)) generated by the electric generator by receiving a communication from a wattmeter. The output module 116 can also measure the time (e.g., hours (h)) over which a resource is consumed using any suitable clocking device and can measure the amount of useful work performed using a meter suitable for that type of useful work (e.g., a Kilowatt-hour meter for useful work from consuming electricity or an odometer for useful work from moving an object a specific distance).

Similarly, in the embodiment wherein the modules 102-116 of the present invention are also used to control the various resources, devices, waste streams, and useful work, connections and interconnections between the modules 102-116 and the various resources, devices, waste streams, and useful work allow the system 100 to be controlled in a holistic manner. For example, the resource converter module 106 can communicate to the hot water storage device that the electric generator is generating hot cooling water that needs to be stored. In response to that communication, the resource storage module 110 can automatically activate a pump controlled by that module to pull the hot cooling water into the hot water storage device. And, the present invention can monitor the data flowing through the central server(s) and function as a central location for determining the status of the various modules 102-116 and their associated resources, devices, waste streams, and useful work. Moreover, by monitoring all of that data, the present invention can intercept and override any of those communications based on the activity it is monitoring in the other modules 102-116, such as when the present invention determines that the hot cooling water would be more efficiently utilized by the heater in the resource consumer module 108 than in the hot water storage device in the resource storage module 110. The present invention would then cause the hot cooling water to be redirected to the heater in the resource consumer module 108. In that way, the present invention can holistically monitor and control the entire system 100.

To perform a holistic analysis of the system 100, the present invention uses the data gathered via the input module 102 to holistically analyze the system. For example, the present invention can determine the cost of generating electricity with the electric generator (e.g., $/kW-h) and compare that value with the cost of using electricity supplied in a consumable form from a resource supplier (e.g., a power company). The present invention can make various other determinations regarding the operation of the system 100 in a similar manner (e.g., whether to replace or repair a device, which device is generating the most harmful waste, whether to consume one resource or another, whether to consume a resource or store it for later use, etc.). In making those determinations, the output module 116 receives output information from the various other modules 102-114 regarding the various resources, devices, waste streams, and useful work at each module 102-114 so an analysis of the entire system 100 can be performed in view of each of those modules 102-114. In addition, numerous other external variables can be updated in real time at the input module 102 (e.g., the cost of electricity), which makes those determinations even more accurate, more efficient, and more effective.

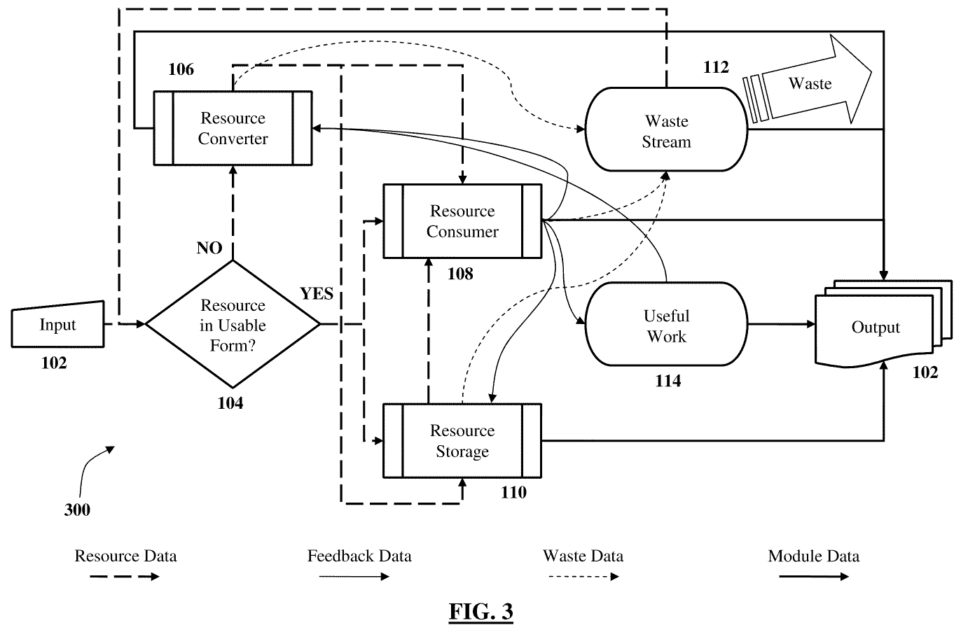

A schematic diagram 300 illustrating the flow of data between the various modules 102-116 of the present invention is provided in FIG. 3, wherein each flow line represents a data exchange. The data includes resource data, feedback data, waste data, and module data. Resource data includes the type, cost, and quantity of each available resource. Feedback data includes operational information about each module, such as demand for consumable resources, demand for useful work, and data related to the efficiency of devices. Waste data includes information quantifying the losses (i.e., waste streams) that occur when a resource is converted, consumed, or stored. And, module data includes resource data, feedback data, and waste stream data and is used by the output module 116 to generate integral tables for use in evaluating the operation of the system 100 and choosing ECMs. The schematic diagram 300 of FIG. 3 is divided into eight areas corresponding to the modules 102-116 described above. Because the functionality of each of those modules and the corresponding flow of data is unique, each of the eight areas is addressed separately.

### Input Module 102

Receiving input includes manually or electronically inputting data into the system to serve as a base line for determining ECMs. Data can be input into the system via a user interface (e.g., PC, laptop or tablet PC, SME PED, PDA, etc.) using any suitable input device (e.g., keyboard, scanner, download, live feed, etc.). For example, a user can manually type an input into a keyboard or the input can be automatically downloaded from a location outside of the system 100, such as by using pull technology to retrieve data regarding the cost of electricity from the local power company's web page.

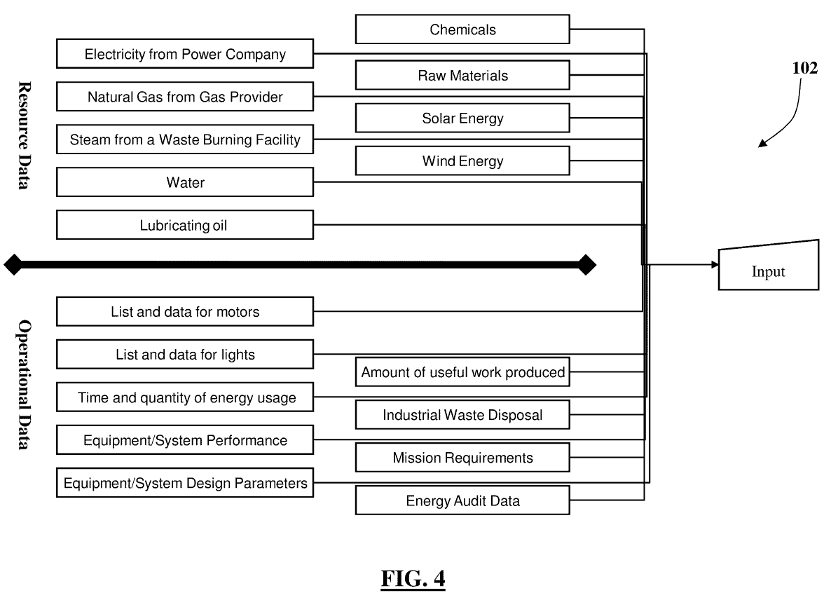

As FIG. 4 illustrates, input data includes both resource data and operational data. A resource is considered any commodity that the system 100 uses that is consumed and is needed to produces useful work, and the operational characteristics of the system 100 describe the manner in which those resources are consumed. Accordingly, resource data includes information regarding the type, cost, and quantity of each resource supplied to the system 100. And, in addition to identifying all of the resource consumers, resource converters, and resource storage devices, operational data includes information regarding the efficiencies, emissions, and financial implications associated with operating each of the resource consumers, converters, and storage devices.

Operational data includes information regarding the operating hours, load profiles, production profiles, resource consumption, lube oil consumption, chemical consumption, energy conversion parameters (e.g., brake specific fuel consumption (BSFC), boiler efficiency, transformer efficiency, etc.), and useful work (e.g., type and quantity of goods manufactured, type and quantity of goods stored, type and quantity of goods moved, distance goods moved, time required to move goods, etc.) for each resource consumer, converter, and storage device. Operational data also includes information regarding the emissions generated from operating each resource consumer, converter, and storage device (e.g., fuel sulfur content, fuel carbon content, reported utility emission data, exhaust emissions, etc.) as well as limits placed on those emissions by various regulatory agencies (e.g., the International Maritime Organization (IMO) and local and federal agencies) and emissions trading schemes (e.g., sulfur (SO₂) trading, carbon trading, CO₂ indexing, etc.). And, financial operational data includes information related to the financial goals that a system user wants to obtain from the system 100, such as Return On Investment (ROI), Net Present Value (NPV), escalation energy rate, payback period, discount rate, and equipment costs (e.g., life, overhauls periods, maintenance, amortized purchase price).

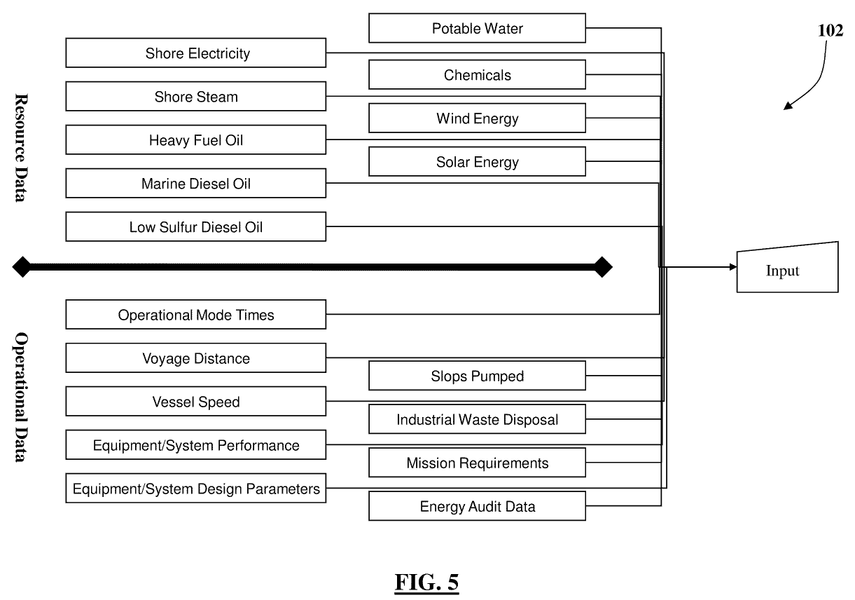

By way of a more specific example, FIG. 5 illustrates input data for a vessel (e.g., a container ship). The main resource and cost for the owner of a vessel is fuel. Resource data for each type of fuel oil can be input separately because each has a different composition (e.g., sulfur content), energy cost, content, and waste stream. Examples of fuels for a vessel are Heavy Fuel Oil (HFO), Marine Diesel Oil (MDO), Low Sulfur Diesel Oil (LSDO), hydrogen, and natural gas. The vessel may also consume other resources for which resource data can be input, such as shore electricity and shore steam. And, operational data for a vessel may include operating hours, load profiles, efficiency of equipment/system, policies and procedures, voyage data, and consumption data. A more detailed listing of resource data and operational data for a vessel is provided below in Table 1 and Table 2. However, it should be understood that the quantity of data variables will increase or decrease with the variance of engines/boilers consuming fuels, the variance in voyage data, and the variance of utilization of shore power or other resources from shore while in port.

TABLE 1
Resource Data

| Type | Examples |
|---|---|
| Fuel | Quantity consumed, unit cost, type, quality/ |
| | characteristics (sulfur content, energy content, |
| | ash, etc.), temperature monitored per engine/boiler |
| Electricity | Quantity consumed, unit cost, voltage, frequency, type of |
| (Shore and/ | charges (fuel surcharge, time of day charge, demand |
| or Vessel) | charge, energy consumption charge, seasonal |
| | charge, etc.) |
| Steam (Shore | Quantity consumed, Unit cost, pressure, temperature, |
| and/or Vessel) | type of charge (similar to above) |
| Potable Water | Quantity consumed, quality, unit cost |
| High Pressure | Quantity consumed, unit cost, pressure |
| Air | |
| Conditioned | Quantity consumed, unit cost, pressure, temperature |
| Air | |
| Chemicals | Quantity consumed, unit cost, types, and their constituent |
| | components (e.g., hydrazine in boiler chemicals) |
| Lubricants | Quantity consumed, unit cost, types, and their constituent |
| | components (e.g., sulfur) |
| Consumables | Quantity consumed, unit cost, types, and their constituent |
| | components (e.g., mercury in fluorescent light bulbs) |

TABLE 2
Operational Data

| Type | Examples |
|---|---|
| Voyage Data | Vessel transit times, maneuvering times, pier times, cargo |
| | operations time, anchor times, ballast condition, draft, |
| | weather/current routing, equipment operation times, |
| | operating parameters of equipment, engine/boiler load |
| | profile, type and quantity of cargo (containers, passenger, |
| | liquids, break bulk, etc.), distance cargo moved, labor |
| | costs |
| Consumer | Load profiles (hours of operation for each device during |
| Data | each operational phase, such as maneuvering hours), |
| | consumption rates, efficiency, in-port hours, at-sea hours |
| Maintenance | Specific historical or manufacturer's data showing cost of |
| Costs | repair and maintenance for operating a piece of equipment |
| | (e.g., the cost to re-wind the coils on an electric motor) |
| Waste Data | Waste discharge quantities, generator emissions, engine |
| | emissions, boiler emissions, CO₂ index, carbon credits |
| Financial | Discount rate, escalation factor, user's desired ROI, vessel |
| Data | life expectancy, desired payback period |

The present invention uses the various input data in connection with the data gathered from various modules 102-116 to holistically determine the existing condition of the system 100 as well as any ECMs that should be taken to optimize resource consumption, efficiency, and emissions of the system 100 while also achieving the user's financial goals. For example, the present invention can determine which resource is most cost effective to use with which resource converter, consumer, or storage device based on such factors as the cost and energy content of each resource and the efficiency and emissions of each resource converter, consumer, and storage device. The present invention can also determine the cost effectiveness of using each resource and each resource converter, consumer, and storage device by using financial data to evaluate several different scenarios. For example, the present invention can determine the resource converter, consumer, or storage device for which it would be most beneficial to invest in reducing its cost and waste profile; determine whether it would be more beneficial to invest in improving the efficiency and waste profile of a resource converter, consumer, or storage device or to invest in a new or alternative one; and/or determine the cost per unit resource at which the savings found in load leveling and engine efficiency improvement will meet the system user's financial criteria. Because all of that data is linked across the system 100, the above calculations are quickly accomplished with the financial implications being generated as output at the output module 116. Moreover, because the financial data can be changed at any time to suit the system user's financial goals and evaluate new scenarios, the present invention provides a sensitivity analysis tool for looking forward in out years, which is particularly useful in the highly volatile energy market.

The options for and complexity of input data will increase with technological advancement, regulatory change, and energy cost increase. Many of those changes can be accounted for by merely changing the input data. And, the modular nature of the present invention allows new modules, resources, resource converters, resource consumers, resource storage devices, and/or useful work to be integrated into the system as those changes require.

### Resource Supply Module 104

As discussed above, a resource is considered any commodity that the system 100 converts or consumes to produce useful work. The resource supply module 104 analyzes the various resources in terms of cost, availability, quantity on hand, and flow. For example, the resource supply module 104 may include a Kilowatt-hour meter for monitoring the total amount of electricity flowing into (i.e., being consumed by) the system 100. The resource supply module 104 may also include a fuel gauge for monitoring the total amount of fuel on hand, such as in a storage tank. The resource supply module 104 can also evaluate the amount of each resource converted, consumed, or stored by each resource converter, consumer, and storage device to more accurately monitor the availability of each resource.

In the embodiment where the modules 102-116 are also used to monitor the various resources, devices, waste streams, and useful work, the Resource Supply Module may be used to monitor the amount of resources available for consumption, can then be used to indicate and/or predict when resources need to be replenished as well as when a resource converter, consumer, or storage device should stop drawing on that resource. Moreover, monitoring the amount of resources available for consumption over time allows the present invention to project how long each resource will last in different scenarios and choose the scenario that most effectively utilizes those resources. The resource supply module 104 may also be used to order additional resources (e.g., barrels of fuel oil or lube oil) based on the demand for those resources observed within the system 100.

### Resource Conversion Module 106

In the present invention, the resource conversion process is implemented when a convertible resource (i.e. a resource that is in a form that is not directly useable by a resource consumer) comes into the system 100 or is produced as a byproduct of processes within the system 100. There is a quantifiable amount of convertible resource consumed and a corresponding amount of consumable resource by each resource converter based on that resource converter's efficiency. The resource converter module 106 analyzes each resource converter's efficiencies by tracking the variables that may effect each resource consumer's efficiency, such as ambient conditions and load conditions, through feedback loops. Based on those efficiencies, the resource converter module 108 can determine how much of a convertible resource is consumed and the resulting amount of consumable resource produced by each resource consumer. In the alternative, the resource converter module 106 can calculate the amount of a convertible resource actually consumed by a resource converter to produce a specific amount of consumable resource to determine the efficiency of that resource converter.

In the examples illustrated in FIG. 1, the electrical transformer converts electricity at one voltage (e.g., 480 or 6600 volts) to another voltage (e.g., 120 or 240 volts) with a loss of energy primarily in the form of heat (i.e., i²r losses); the combustion engine converts the chemical energy found in fuel (e.g., diesel) into mechanical energy (e.g., rotating a crank shaft); the combustion generator converts the chemical energy in fuel (e.g., diesel) into electrical energy; the natural gas boiler converts the chemical energy in fuel or natural gas into thermal energy; the wind turbine converts the kinetic energy of wind into mechanical energy (e.g., rotating the turbine blades); the water turbine converts the kinetic energy of flowing water into mechanical energy (e.g., rotating the turbine blades); the solar panel converts solar energy into electrical energy; the adsorption chiller converts one form of thermal energy (e.g., heated exhaust gas) into another form of usable thermal energy (e.g., chilled fluid), and the fuel cell converts a chemical (e.g., an oxidant, such as hydrogen) into electrical energy. Some of those resource conversions, however, require the resource to be converted more than once. For example, the combustion generator is actually a combustion engine that first converts the chemical energy in fuel into mechanical energy (e.g., rotating a flywheel), and that mechanical energy is then converted to electrical energy. The electrical energy may then be converted again, for example, by a transformer to lower or higher voltage electricity.

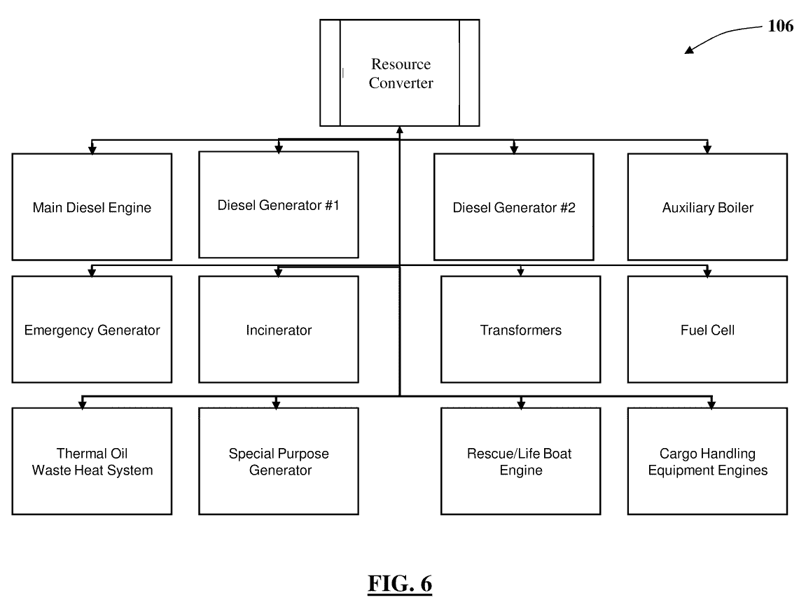

Returning to the example of a vessel, the most typical resource that requires conversion on a vessel is fuel oil. FIG. 6 illustrates some typical resource converters that would be analyzed by a vessel's resource converter module 106, such as a main diesel engine. The main diesel engine is responsible for moving the vessel through water by converting the chemical energy in diesel fuel into the rotation of the propeller shaft. During that resource conversion, less than half the energy is converted to rotational energy of the propeller shaft. Instead, a majority of the energy from the converted resource is generated as waste streams. Those waste streams are mostly in the form of thermal energy in the exhaust and cooling water. The efficiency of the engine (i.e., the amount of chemical energy in the fuel converted to rotational energy of the propeller shaft) is dependent upon engine design, load, ambient conditions, fuel characteristics, maintenance, etc. as well as factors such as the amount of fuel consumed and the amount useful work produced. But, when considered holistically with the rest of the system 100, that efficiency is improved by also considering the amount of energy that can be recaptured from the waste streams for use elsewhere in the system 100. Accordingly, the present invention can determine the efficiency of various resource converters as individual units isolated from the system 100 as well as cumulatively in terms of their contributions to the rest of the system 100.

Table 3 provides a list of typical parameters utilized by the present invention in quantifying and optimizing resources on a vessel based on resource conversion.

TABLE 3
Resource Converter Parameters

| Resource | |
|---|---|
| Converter | Parameter |
| Main | Fuel consumption and emission performance curves, fuel |
| Propulsion | consumed, quantity, quality (sulfur content, energy content, |
| Engine | ash, etc), temperature, chemicals consumed, shaft output |
| | and load profile, lubricating oil consumed, waste |
| | generated |
| Diesel | Fuel consumption and emission performance curves, fuel |
| Generators | consumed, quantity, quality (sulfur content, energy content, |
| | ash, etc), temperature, chemicals consumed, electrical |
| | output and load profile, quantity, voltage, frequency, |
| | lubricating oil consumed, waste generated |
| Auxiliary | Fuel consumption and emission performance curves, fuel |
| Boiler | consumed, quantity, quality (sulfur content, energy content, |
| | ash, etc), temperature, chemicals consumed, thermal output |
| | and load profile, quantity, temperature, pressure, |
| | waste generated |
| Transformers | Type, efficiency load profile curves, no load losses, thermal |
| | rating, location (e.g., whether it is in an air conditioned |
| | space) |

Each of those parameters can be considered when analyzing each resource converter as an individual unit isolated from the system 100 as well as cumulatively in terms of its contributions to the rest of the system 100.

Many of the resource converters in a system 100 will operate at different efficiencies corresponding to different loads. Accordingly, using the diesel generator as an example, one ECM of the present invention may be to increase the load on the generator to a point where the diesel engine is operating at its maximum efficiency level, thereby lowering the cost per kW-h produced by the generator. Looking at the system 100 holistically, such an increase in load may be justified, for example, by a need for additional thermal energy that can be captured from the generator's waste stream (e.g., exhaust or cooling water) where that thermal energy would have otherwise required consumption of some other, more expensive or more polluting resource. Capturing the waste streams from the generator in that way may increase the generator's efficiency enough to justify its use.

In the alternative, if two generators are operating at a load lower than peak operational efficiency because the amount of load is too large for a single generator, an ECM of the present invention may be to reduce the load on the generators to a point were only one generator is required and is operating at its maximum level of efficiency, thereby lowering the cost per kW-h produced by the generators. That increase in efficiency of the generators may, however, impact the amount of thermal energy available in the waste stream that could have been utilized by some other resource consumer. That loss of available waste stream energy may cut against reducing the loads on a pair of generators, as described.

To optimize resource consumption cost in a system using the efficiencies of resource converters, the present invention takes the performance curve of the each resource converter and plots it against the total load on that resource converter. Those curves are plotted based on the values calculated by the diesel generator sub-module within the resource consumer module 106. For example, the kW-h cost is calculated using the cost per unit of fuel, the efficiency curve of the engine, and the total amount of load on the generator. The amount of useful energy in the generator's waste stream is also dependent on the load and is also calculated by the diesel generator sub-module.

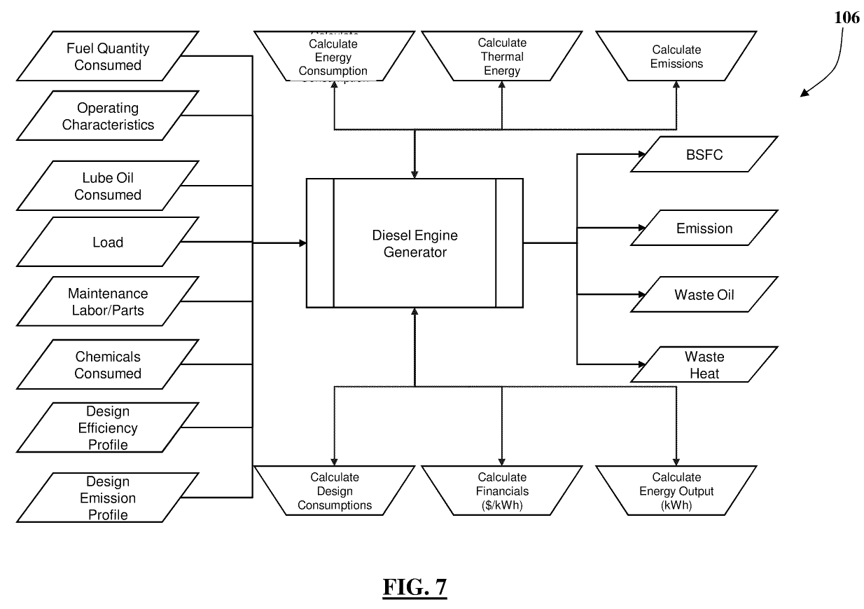

FIG. 7 illustrates an example of the data input, data output, and calculations executed by a resource converter sub-module—in this case, a diesel generator sub-module. Data, including the results of any calculations, can be input from or output to substantially any of the modules 102-116 or sub-modules and/or sub-modules. For example, the diesel generator sub-module may receive emissions profile information for the generator from the input module 102, calculate the emissions using that information and the information gathered at the generator by the diesel generator sub-module, and communicate the results of that calculation to the exhaust gas sub-module and/or cooling water sub-module within the waste stream module 112. That data can also be input from or output to any other sub-module within the resource converter module 106.

### Resource Consumer Module 108

The resource consumer module 108 operates in a similar manner to the resource converter module 106, except that the resource consumed by the resource consumer module 108 is converted directly into useful work rather than being converted into another form of energy or resource. There is a quantifiable amount of useable resource consumed and a corresponding amount of useful work produced by each resource consumer based on that resource consumer's efficiency. The resource consumer module 108 analyzes each resource consumer's efficiencies by tracking the variables that may effect each resource consumer's efficiency, such as ambient conditions and load conditions, through feedback loops. Based on those efficiencies, the resource consumer module 108 can determine how much of a resource is consumed and the resulting useful work produced by each resource consumer. In the alternative, the resource consumer module 108 can calculate the amount of a resource actually consumed by a resource consumer to produce a specific amount useful work to determine the efficiency of that resource consumer.

Using lighting as an example resource consumer, the lighting sub-module within the resource consumer module 108 evaluates the type of lighting, hours of operation, amount of heat dissipated, life of the lighting equipment, etc. as well as the energy usage and associated waste of the lighting equipment. The main waste stream of lighting is heat energy. And, if the lighting is in a environment that is air conditioned, the resource consumer module 108 can determine any additional load requirements on the system 100 that may be needed to remove that heat energy, for example, by monitoring the conditions measured at the air conditioning sub-module (e.g., the load on the air conditioning system, the efficiency of the air conditioning system, and cost of the energy required to operate it). Based on those determinations, the present invention can evaluate various lighting options and provide a system user with a number of efficient lighting alternatives (i.e., ECMs) from which to choose. The system user can choose from those alternatives via one of the user interface devices of the output module 116. That choice may be based on an integral table listing the various resource consumer efficiency levels and associated costs that are monitored by the resource consumer module 108. And, by monitoring conditions within the system 100 in real time, the present invention allows the system user to track the effectiveness of that choice via one of the user interface devices of the output module 116.

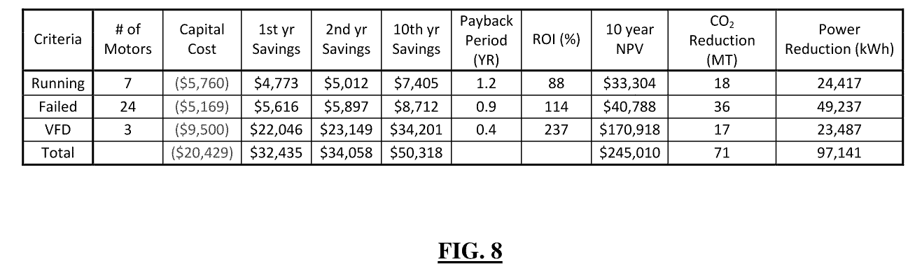

Returning to the example of a vessel, a single vessel typically includes several electric motors. The system user may utilize the resource consumer module 108 of the present invention to determine which of those motors to use in its present condition, which of those motors to use with a Variable Frequency Drive (VFD), or whether to repair or replace a motor when a motor fails. As FIG. 8 illustrates, all of the electric motors in an electric motor sub-module are evaluated based on the financial criteria and other data input by the system user via the input module 102. Only the electric motors that meet the system user's financial criteria are included in the illustrated table.

Each resource consumer sub-module includes automatic look up tables of costs and efficiencies for standard motors, high efficiency motors, and premium efficiency motors manufactured in at least the past twenty years, including those currently available for purchase. In the case of an electric motor sub-module, that sub-module includes a table that quantifies the price and efficiency of using a VFD with each electric motor. VFDs save energy by allowing the speed of a motor to be adjusted to meet system demands. And, the electric motor sub-module includes a listing of the cost of labor to replace each electric motor, the cost to re-wind each electric motor and the inherent loss of efficiency incurred from the rewind process, the number of hours for each phase of operation (e.g., at sea, in port, etc.), whether each electric motor can be used with a VFD, and the associated percent load for each electric motor, which may be input into the input module 102 for use by the electric motor sub-module. And, if other resources must be converted by resource converters to provide electricity to the electric motors, the resource data and operational data associated with each of those resources and resource converters is also available to the electric motor sub-module so it can determine the cost of generating the electricity required to operate the electric motors. The electric motor sub-module then calculates the overall operational cost, resources consumed, and emissions generated for operating each electric motor, including that for any resource and resource converter that must be used to generate electricity for the electric motor(s).

Based on the calculations performed by the electric motor sub-module, the system user is provided with integral tables from which the system user can choose various ECMs. As FIG. 8 illustrates, seven electric motors have satisfied the system user's financial criteria for immediate replacement of existing motors in good condition with premium efficiency motors. Twenty-four motors should be replaced with premium efficiency motors (vice standard efficiency) when they eventually fail according to the system user's financial criteria. And, three motors may be modified with a VFD to meet the system user's financial criteria. The costs/savings associated with replacing each of the electric motors with premium efficient motors is based on input data for electric motors that are currently available for purchase provided in those integral tables. Accordingly, a system user can choose from the following ECMs based on the illustrated integral tables generated by the electric motor sub-module: replace an existing motor in good running condition with a premium efficient motor, replace an existing motor that has failed to meet the system user's financial criteria with a premium efficient motor, and/or modify an existing electric motor to utilize a VFD. Although FIG. 8 calculates the costs/savings associated with each ECM based on a ten-year life cycle, the actual time period for each electric motor's life cycle can be established for each resource consumer on an individual basis.

The resource converter module 106 and its associated sub-modules can perform a similar lifecycle cost analysis for the various resource converters in the system 100. Similarly, just as the resource converter module 106 and its associated sub-modules can perform a lifecycle cost analysis similar to that of the resource consumer module 108 and its associated sub-modules, the resource consumer module 108 and its associated sub-modules can also perform an efficiency/load balancing analysis similar to that performed by the resource converter module 106 and its associated sub-modules. For example, because all of the modules 102-116 and sub-modules are integrated across the system 100, the diesel generator sub-module can be analyzed in conjunction with the electric motor sub-module when two diesel generators must be operated outside of their range of peak efficiency because the amount of electricity required by the electric motors does not leave enough reserve capacity for the operation of only one generator for best cost. The resource consumer module 108 can then suggest ECMs for reducing the overall demand for electricity, and therefore the load on the diesel generators, such as utilizing premium efficient motors and VFD drives so that a single diesel generator can be operated at peak efficiency. In the alternative, if a single generator is required to meet the demand for electricity of the electric motors but is oversized so that it operates at a load below its peak efficiency, the resource consumer module 108 can suggest the ECM of installing a smaller generator. Accordingly, the present invention is able to provide ECMs for optimizing resource consumption across the entire system 100 by holistically looking at each of the resources, devices, and useful work in each of the modules 102-116 and their associated sub-modules and determining the overall effect that changing any of those variables will have on the system 100 and each of its modules 102-116 and sub-modules.

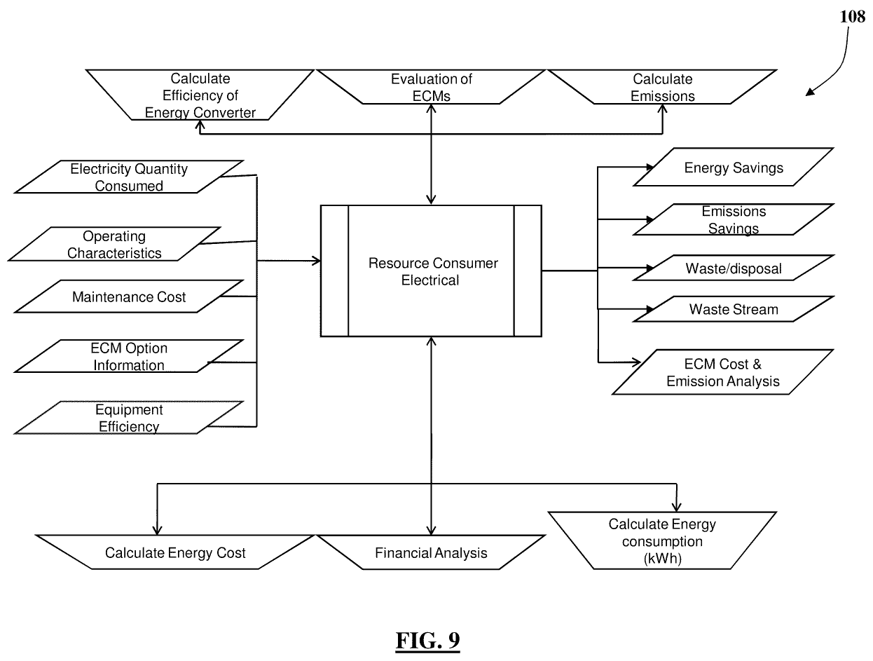

FIG. 9 illustrates an example of the data input, data output, and calculations executed by an electric resource converter sub-module within the resource consumer module 108, such as the lighting or electric motor sub-modules described above. Data, including the results of any calculations, can be input from or output to substantially any of the modules 102-116 and/or sub-modules. For example, the electric motor sub-module may receive information regarding the options for generating the electricity needed to operate the electric motors in that module (i.e., “ECM Option Information”) from the resource supply module 104 and/or the resource converter module 106, evaluate the various ECMs using that information, and communicate the results of that analysis to the output module 116 for selection by the system user via one of the user interface devices of the output module 116. That data can also be input from or output to any other sub-module within the resource consumer module 108.

### Resource Storage Module 110

A device is considered to be a resource storage device when its primary function is to be used for one or both of the following functions: to help load level a resource that allows a resource converter or resource consumer to operate at its most efficient load profile; or to minimize or defer the use of a resource for cost benefit or availability reasons. And, by monitoring the cost of each resource at the resource supply module 104 in conjunction with the cost of using each storage device at the resource storage module 110 versus the cost of using that resource at the consumer module 108, the present invention can determine the financial benefits as well as the waste reductions associated with the storage of a resource in a resource storage device versus its immediate use in a resource consumer.

Using an ice storage system as an example resource storage device, ice storage can be used to defer the use of electricity to off-peak hours when power companies offer electricity at rates that are substantially lower than for on-peak hours. Such rate differentials are typical in warmer climates where high air conditioning use in the afternoon causes a strain on the power grid, thereby causing power companies to raise rates during the afternoon hours and lower rates during the late evening and early morning hours. Accordingly, an ice storage system will allow all or part of a system's electricity use for air conditioning to occur during off-peak hours rather than on-peak hours by generating ice for air conditioning purposes during off-peak hours. Moreover, where a generator is used to generate electricity, the ice storage system can be used to load level by using the generator to make ice only when the generator requires an additional load to be operating at its peak load efficiency. Similarly, the ice storage system can be used to allow air conditioning equipment to operate at peak load efficiency instead of at a load determined by the overall cooling requirements of the system 100 by supplementing the cooling from the air conditioning equipment with cooling from the ice storage system.

Returning to the example of a vessel, the typical function of a resource storage device on a vessel is to help load level diesel generators and allow the generators to operate at their most efficient load while still providing the required amount electricity during the periods when power is needed. And, on a vessel, such load leveling focuses primarily on resource conservation and emissions reduction. Accordingly, an ice storage system can be used to minimize the use of a vessel's air conditioning compressor while the vessel is in port, thereby reducing the emissions generated while the vessel is in port, by allowing ice to be made while the diesel generator is operating on a lower cost fuel type at sea (i.e., HFO).

Another example of the use of a resource storage device for resource conservation and waste reduction on a vessel is the use of a compressed air system. Compressed air is typically stored in air tanks so that it is available when surge demands are present. By providing larger air tanks, smaller air compressors can be used, thereby reducing the resources consumed and emissions produced by each air compressor.

The main variables considered for reducing cost and waste for a diesel generator on a vessel are: cost of diesel and electricity, efficiency of each generator at a specific load profile, maintenance cost savings from generator load optimization, power required from each resource consumer (e.g., an air conditioning system) at a specific load profile, emissions of each generator at the specific load profile, waste from each resource consumer at the specific load profile, value of waste (e.g. recapture of energy from waste streams or costs from waste disposal), and the financial criteria of the system user. Based on those variables, the present invention provides the system user with various ECMs from which to choose to improve efficiency and reduce waste. Those ECMs might include: investing X dollars on improving a generator's efficiency and emissions profile, which will reduce the benefits of investing in resource storage devices; investing X dollars on efficiency improvements to resource consumers utilizing electricity from the generator (e.g., electric motors, lighting, air conditioning, etc.), and identifying the times and associated resource costs at which the savings found in load leveling and generator efficiency improvement brought about by resource storage devices meet the system user's financial criteria. And, because all of the modules 102-116 and sub-modules are integrated across the system 100, obtaining the associated data and making such calculations is quickly accomplished and output to a system user via one of the user interface devices of the output module 116.

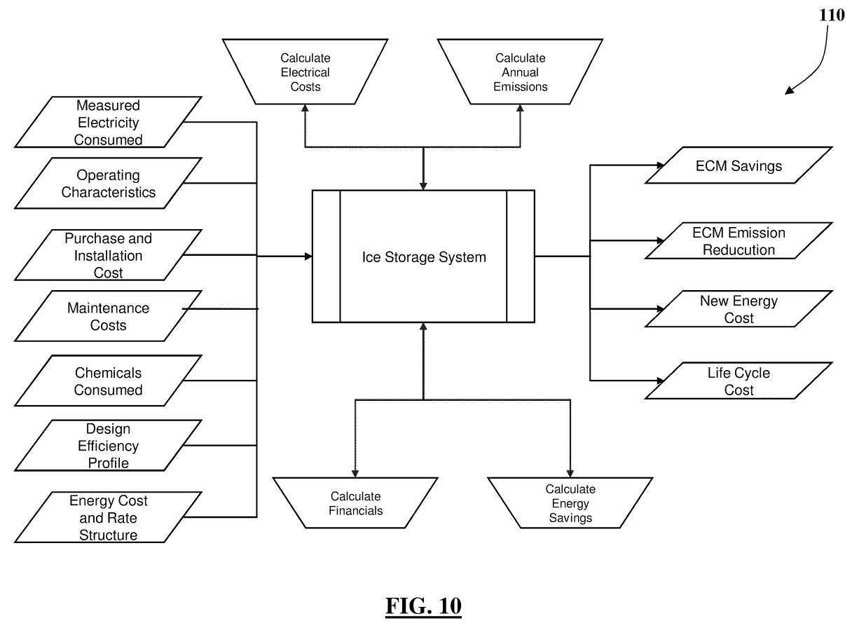

FIG. 10 illustrates an example of the data input, data output, and calculations executed by an ice storage system sub-module within the resource storage module 110. Data, including the results of any calculations, can be input from or output to substantially any of the modules 102-116 and/or sub-modules. For example, the ice storage system sub-module may use information regarding the energy costs and rate structures for electricity from the input module 102 and/or the resource supply module 104, calculate the costs of using electricity to make ice during off-peak hours versus the cost of using electricity to generate an equivalent amount of cooling with an air conditioner during on-peak hours, and communicating potential ECMs and associated costs to the output module 116 for selection by the system user via one of the user interface devices of the output module 116. That data can also be input from or output to any other sub-module within the resource storage module 110.

### Waste Stream Module 112

Waste streams are generated in the processes of converting convertible resources into consumable resources, storing resources, and consuming resources to produce useful work. The present invention calculates wastes and emissions based on operational performance, loading, and measured data. Some waste streams can be utilized to improve the efficiency of those processes while others create additional costs and/or have a negative environmental impact. Accordingly, the waste stream module 112 analyzes the various waste streams for recapture or disposal. The most common form of waste that can be recaptured from a process is thermal energy. And the most common form of waste that must be disposed of are pollutants, such as oily waste (e.g., used oil from oil changes, dirty fuel oil from sludge tanks, etc.), industrial waste (e.g., used oil filters, used chemicals, etc.), exhaust gas particulates (e.g., sulfur and carbon particulates), and miscellaneous waste (e.g., waste that can be disposed of as standard trash). Two other waste sources include equipment vibration and sound energy, both of which represent inefficiencies and affect to immediate environment.

Using the example of thermal energy as a waste stream, a thermal energy sub-module within the waste stream module will evaluate and quantify the thermal requirements within the system while the resource converter module 106, the resource consumer module 108, and the resource storage module 110 each evaluate and quantify the amount of thermal energy available from those modules 106-110. Accordingly, as discussed above, the present invention can utilize the thermal energy generated by one device to offset the load on devices that consume resources solely for the purpose of generating thermal energy (e.g., electric hot water heaters), thereby reducing the overall consumption of resources required to generate that amount of thermal energy. Such recapture of thermal energy may change the entire electric utility rate plan for the system 100 when looked at holistically because such a holistic view allows the present invention to determine the amount of waste that can be utilized to improve the efficiency of the devices used to accomplish the desired amount of useful work. Moreover, the present invention can quantify the cost of disposing of harmful waste streams in both monetary and environmental terms, which can also be factored into the cost of using a specific device.

Returning to the example of a vessel, the waste streams on a vessel are particularly important with respect to diesel engines, which produce a significant amount of thermal energy in the exhaust gas and cooling water that can be utilized to improve the efficiency of other devices in the system 100. Vessels typically include both diesel generator engines for generating electricity as well as diesel main engines for vessel propulsion. Accordingly, a thermal boiler may be provided to capture thermal energy from the exhaust gas and cooling water from those engines. Thermal boilers convert thermal waste energy into usable thermal energy (e.g., steam or thermal oil) that is consumed by resource consumers such as lube oil and fuel oil heaters. The efficiency of the boiler, like the main propulsion engine, is dependent on a host of variables and can be determined as an individual unit isolated from the system 100 as well as cumulatively in terms of its contributions to the rest of the system 100. A thermal boiler sub-module can be utilized to evaluate the feasibility of installing a thermal boiler for in-port use on the generator as well as for at-sea use on the main engines.

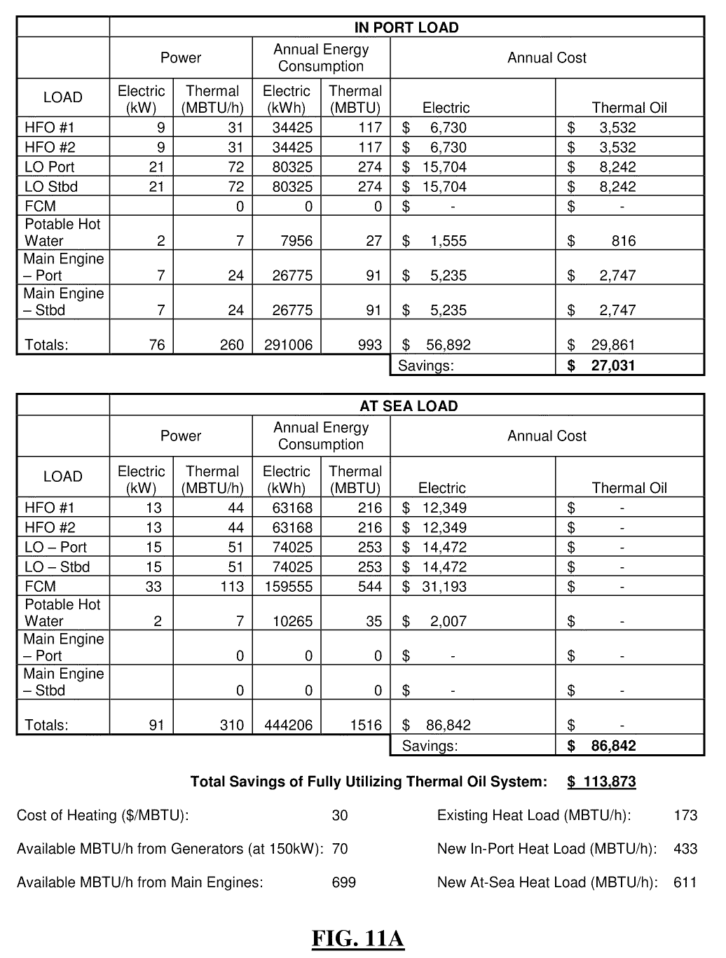

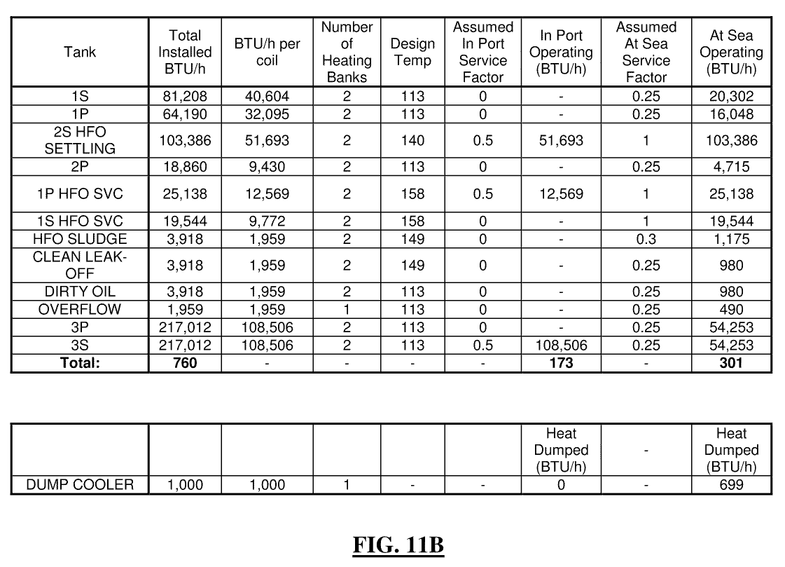

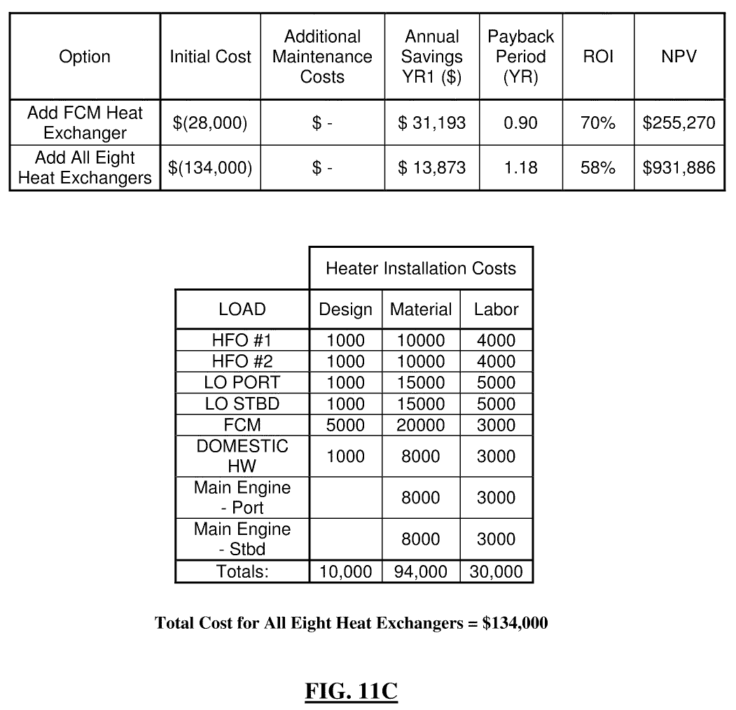

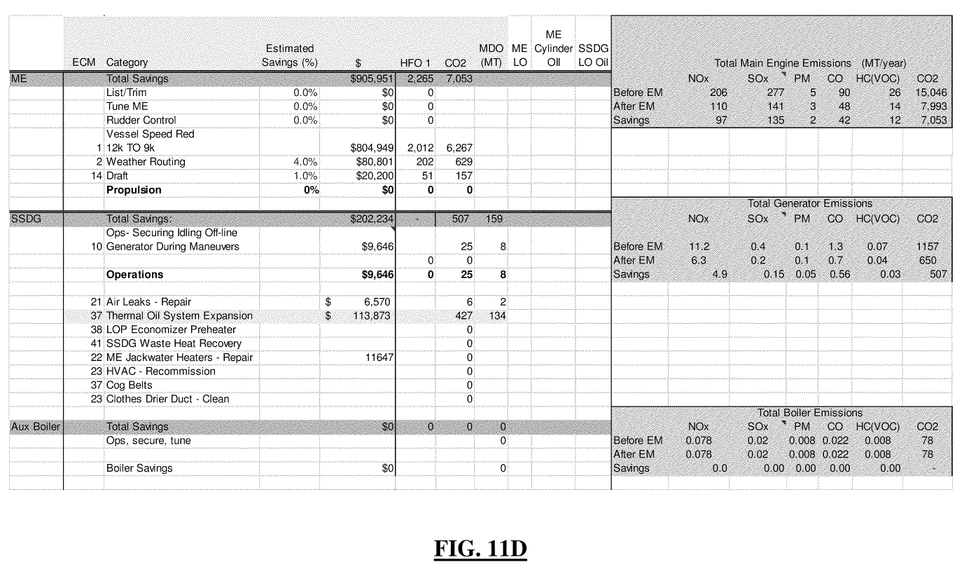

Because each of the modules 102-116 and sub-modules is integrated across the system, the present invention can determine the effect that changing a single variable will have on any benefits that may be obtained from recapturing thermal energy with a thermal boiler. For a thermal boiler used to recapture thermal energy from the generator at port and from the main engines at sea, one such variable is the speed of the vessel. More specifically, if the vessel is slowed down, the number of hours the vessel will spend at port will decrease, which will reduce the available hours for the utilizing the thermal energy available from the generator while increasing the available hours for utilizing the thermal energy available from the main engines. Accordingly, slowing the vessel down will completely change the financial analysis by reducing the savings associated with in-port use of the thermal boiler with the generator while increasing the savings associated with at-sea use of the thermal boiler with the main engines. Thus, integral tables such as those illustrated in FIGS. 11A-11D are presented to a system user via one of the user interface devices of the output module 116.

FIGS. 11A-11D illustrate exemplary integral tables generated by a thermal energy sub-module for examining the feasibility of the ECM of installing a thermal boiler for in-port use on the generator and for at-sea use on the main engines, as described above. More specifically, FIG. 11A illustrates the energy cost savings associated with utilizing the thermal oil system (e.g., $27,031+$86,842=$113,873) based on the difference in energy costs for electricity and thermal oil. The operating characteristics (e.g., Existing Head Load, Available MBTU/H from Generators, and Available MBTU/H from Main Engines) are calculated as illustrated in FIG. 11B, by way of example, for Existing Heat Load. And, as FIG. 11C illustrates, the thermal energy sub-module can also calculate the savings in energy (e.g., in MDO) and waste (e.g., CO₂ emissions) for each ECM in addition to the energy cost savings associated with utilizing the thermal oil system.

In FIG. 11C, the ECM of installing a thermal boiler is listed among other ECMs as ECM number 37, “Thermal Oil System Expansion.” Listing the energy costs, energy savings, and waste savings associated with different ECMs together in single table as illustrated in FIG. 11C allows a user of the present invention to pick which ECM, or combination of ECMs, provide the desired results. It also allows the user to adjust certain inputs at the input module 102 and observe the holistic effect on the system 100 as well as on each of the various ECMs. Moreover, a user can compare the results of those different inputs side-by-side. For example, FIG. 11D illustrates the calculated life cycle cost and financials of adding a heat exchanger to a fuel control module (FCM) electric heater versus adding heat exchangers to the FCM electric heater plus seven other sources of thermal waste energy. The life cycle costs are calculated based on such factors as the installation cost and maintenance costs (though there are no maintenance costs in the illustrated example) associated with each option. Generating results in such integral tables using different variables from each of the modules 102-116 and sub-modules of the system 100 allows the system user to quickly perform ECM analyses for various combinations of different input variables and immediately observe the associated costs and benefits. Accordingly, the integral charts of the present invention provide a valuable tool for choosing the appropriate ECM to implement in a system 100.

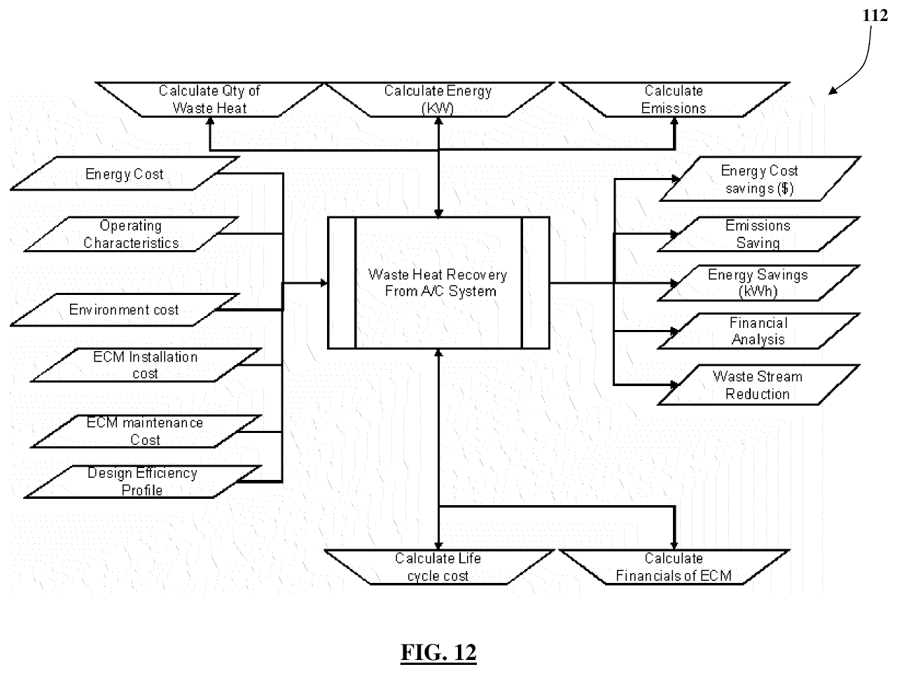

FIG. 12 illustrates an example of the data input, data output, and calculations executed by a thermal energy sub-module within the resource storage module 110 for waste heat recovery from an air conditioning system. Data, including the results of any calculations, can be input from or output to substantially any of the modules 102-116 and/or sub-modules. For example, the thermal energy sub-module may receive information regarding the amount of thermal energy being produced by a diesel generator from the diesel generator sub-module in the resource converter module 106, calculate the amount of thermal energy required by the system 100 and the various financials associated with various ECMs (e.g., reducing the vessel's speed), and communicating the potential energy savings associated with each of those ECMs to the output module 116 for evaluation by the system user via one of the user interface devices of the output module 116. That data can also be input from or output to any other sub-module within the waste stream module 112.

### Useful Work Module 114

As discussed above, useful work is the end result sought to be accomplished from resource consumption. Accordingly, the useful work module 114 analyzes the amount of useful work performed within a system 100. For example, the useful work module 114 may include wet and dry thermometers for measuring the amount of heat removed from or added to air by an air conditioner or heater, respectively. And, in the example of a vessel, the useful work module 114 may measure the distance the vessel moves using the propulsion of the main engines. By analyzing the actual amount of useful work produced by each resource consumer to move the vessel that distance, the useful work module 114 can be used in real time to determine the actual efficiencies of using particular resources and devices to accomplish useful work.

### Output Module 116

The output module 116 takes advantage of the unique characteristic of the present invention wherein all of the modules 102-116 and their respective sub-modules are integrated to seamlessly share data with one another for use by the present invention to generate various results. The output module 116 provides those results in integral tables that allow a complete financial understanding of how the various variables effect one another. Those tables also allow multiple scenarios to be easily and quickly evaluated when any of those variables is changed. The quantification and the interrelationships between resource supply, consumption, and the resulting emissions are valuable in that those tables can be used to identify the most cost effective and environmentally sound ECMs available for the system 100.

For example, the tables generated by the output module 116 can be used to compare results for the present state condition (i.e., the base line) for the system 100 with potential future state conditions of the system 100 that can be achieved by taking various ECMs to reduce resource consumption, system costs, and emissions. Accordingly, the output module 116 can provide a summary of the individual benefits of each ECM as well as a summary of the cumulative benefits of different ECMs taken together. And, because there are generally two ways to optimize resource consumption—(1) to replace an older, less efficient device with a more efficient device or (2) to improve the efficiency and operational practices for a device, including waste stream recapture—the ECMs listed in the integral tables generated by the output module typically include a combination of the two.

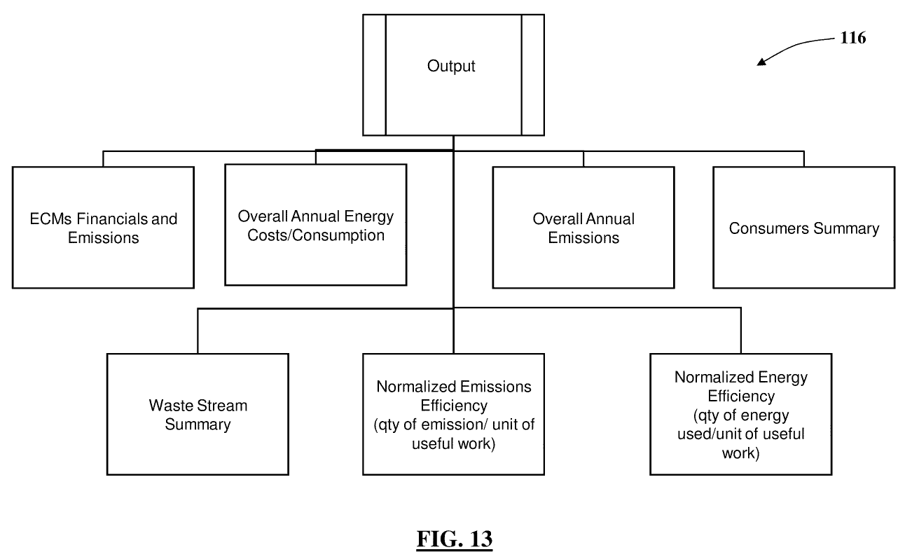

In order to compare results and show improvement, the output module 116 normalizes the base line per unit efficiency of the system 100 (i.e., the amount of useful work produced per unit of resource consumed). The output module normalizes the per unit efficiency of the system 100 by converting all of the resources consumed by the system 100 into common units, summing them, and dividing that value by the total amount of useful work performed by the system 100. Substantially the same process is utilized to normalize the per unit waste generated for the amount of useful work performed by the system 100 (i.e., the amount of each particular emission per unit of useful work). The output module 116 also generates normalized values for per unit efficiency and per unit emissions based on proposed ECMs for comparison with those base line values. FIG. 13 illustrates some of the other types of data generated by the output module 116 for use in such comparisons. For example, in addition to calculating the per unit efficiency and per unit emissions, the output module can also calculate values for the lifecycle costs, emissions analysis (e.g., CO, CO₂, SOx, NOx, HC, CO₂ indexing, etc.), and financial criteria (e.g., ROI, payback, NPV, etc.) for each device utilized in the system 100.

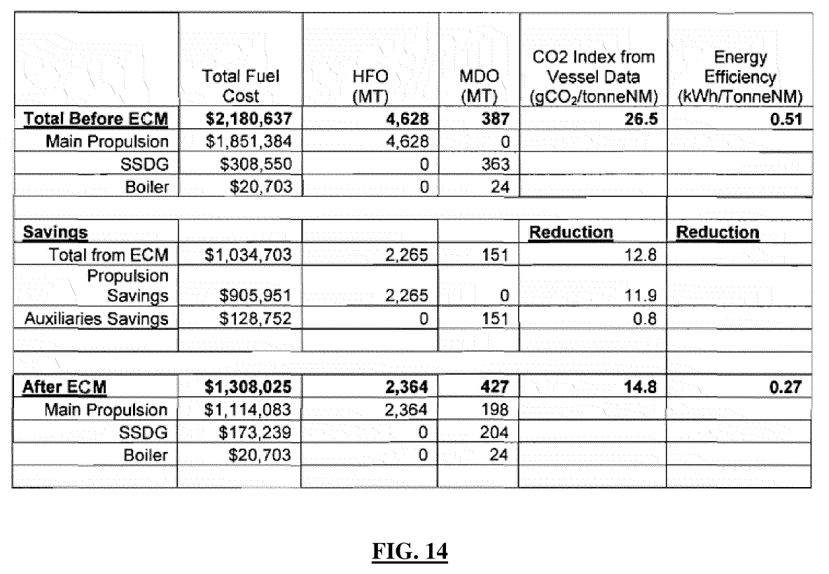

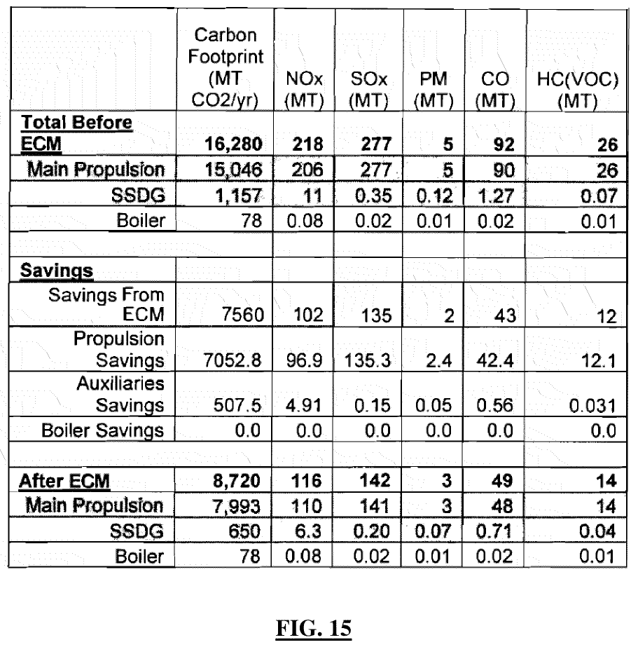

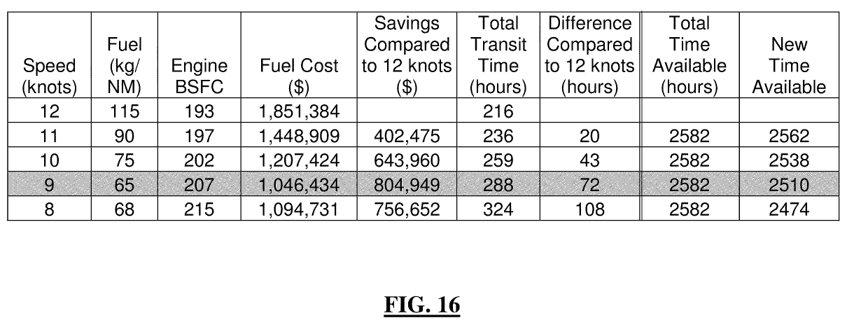

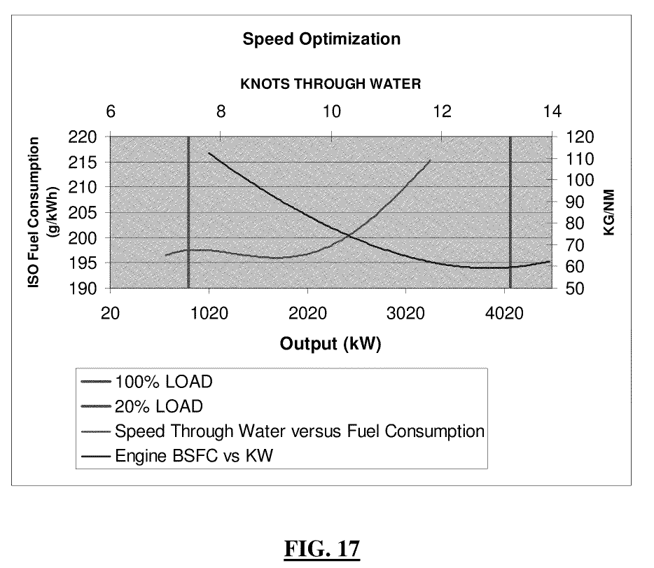

Returning to the example of a vessel, FIG. 14 illustrates an example of a summary savings report for energy for a vessel audit, including the resource consumption, cost, and waste associated with various equipment on the vessel both before and after an ECM is implemented on each of those pieces of equipment. And, FIG. 15 illustrates an example of a summary savings report for emissions for a vessel audit, including the individual and total emissions associated with several pieces of equipment on the vessel both before and after an ECM is implemented on each of those pieces of equipment. Those tables summarize energy and emissions savings for a main engine, a ships service diesel generator (SSDG), and a boiler of a vessel as the result of an ECM aimed at improving the efficiency and reducing the emissions of that equipment. And, in lieu of improving equipment efficiency and reducing emissions, FIG. 16 illustrates an example of a summary savings report for optimizing a vessel's speed to optimize consumption. As that figure illustrates, compared to a baseline of 12 knots, the total savings is optimized at 9 knots (i.e., savings of $804,949). The results of that optimization may also be graphed by the output module, as illustrated, for example, in FIG. 17. FIG. 17 is a plot of the results of the normalized resource consumption for vessel speed in accordance with the analysis illustrated in FIG. 16.

### Operation

If the present invention were utilized in a system comprising two resources (e.g., diesel fuel and electricity), one resource converter (e.g., a diesel generator), and one resource consumer (e.g., a 100 Watt (W) light bulb), the analysis of the present invention could be used to determine which combination of resource, resource converter, and/or resource consumer will most efficiently accomplish a desired amount of useful work (e.g., powering the 100 W light bulb for eight hours (8 h)). Assuming that the first resource (i.e., diesel fuel) must be converted into a consumable form by the resource converter (i.e., the diesel generator) and the second resource (i.e., electricity) is already provided in its consumable form, the present invention will determine the amount of energy required to perform the desired amount of useful work (100 W×8 h=0.8 kW-h) and the costs associated with each resource for performing that amount of useful work. The cost associated with using the first resource (i.e., diesel fuel) must take into account the consumption of the resource converter (e.g., 0.085 g/kW-h) in converting the first resource into a consumable resource (i.e., electricity). The per unit cost of the first resource (e.g., diesel fuel=$1.90/gallon) is then used to calculate the cost of generating the desired amount of useful work using the first resource (0.8 kW-h·0.085 g/kW-h·$1.90/g=$0.13). Similarly, the per unit cost of the second resource (e.g., on peak electricity=$0.15/kW-h and off peak electricity=$0.06/kW-h) is used to calculate the cost of generating the desired amount of useful work using that consumable resource (0.8 kW-h·$0.15/kW-h=$0.12 on peak and 0.8 kW-h·$0.06/kW-h=$0.05 off peak).

Although a general comparison of the costs associated with using each of the two resources suggests that it will always be less costly to utilize the second resource (electricity), the present invention's ability to analyze waste (e.g., heat energy) provides a more accurate determination of which resource will be the least costly. For example, the heat energy emitted by the resource converter (diesel generator) may offset the higher costs associated with the first resource (diesel fuel). Thus, the present invention can utilize the percent of energy lost as heat energy during conversion of the first resource (e.g., 30%), the amount of the first resource consumed to generate the desired amount of useful work (0.8 kW-h·0.085 g/kW-h=0.068 g), and the potential energy of the first resource (e.g., diesel fuel=42.9 kW-h/g) to determine the amount of heat energy (i.e., useful waste) that can be recaptured from the resource converter (0.30·0.068 g·42.9 kW-h/g=0.875 kW-h). The amount of heat energy that can be recaptured can then be compared to the cost of generating an equal amount of heat energy using the second resource (electricity). The cost of generating that same amount of heat energy with the second resource (electricity) may offset any cost differential (Δ_{on peak}=$0.13−$0.12 =$0.01 and Δ_{off peak}=$0.13−$0.05=$0.08) if the combined cost of generating the desired amount of useful work and heat energy with the second resource ($0.12+0.875 kW-h·$0.15/kW-h=$0.25 on peak and $0.05+0.875 kW-h·$0.06/kW-h=$0.10 off peak) is greater than the cost of generating the desired amount of useful work (0.8 kW-h) and heat energy (0.875 kW-h) with the first resource ($0.13+$0.00=$0.13). Thus, in a case where the first resource (diesel fuel) costs the same regardless of the time of day it is utilized, and the second resource (electricity) is more expensive during on-peak hours (e.g., during the night in the winter) than during off-peak hours (e.g., during the day in the winter), the present invention allows a user to elect to utilize the second resource (electricity) during off-peak hours and utilize the first resource (diesel fuel) during on-peak hours, thereby minimizing the costs associated with generating the desired amount of useful work and heat energy (e.g., $0.13 for diesel versus $0.25 on-peak for electricity). In the embodiment wherein the modules 102-116 also control the various resources, devices, waste streams, and useful work, the present invention may make that election automatically based on the analysis.

The emissions of a resource converter, however, may include more than useful waste energy that can be recaptured. For example, the resource converter (e.g., a diesel generator) may also produce harmful waste (e.g., CO₂). Such harmful waste may have a negative cost associated with it, such as disposal costs (e.g., cost to dispose of spent batteries) or waste-related taxes (e.g., $100 per ton of CO₂ emissions→$1.20 per gallon of diesel). Accordingly, based on the amount of the first resource consumed by the resource converter (0.8 kW-h·0.085 g/kW-h=0.068 g), the present invention may also calculate the associated costs of harmful waste (0.068 g·$1.20/g=$0.08) and add them to the costs of consumption of the first resource ($0.13) to determine the true cost of using that resource ($0.08+$0.13=$0.21) to generate the desired amount of useful work and heat energy. Similarly, the present invention can subtract any cost associated with not using the first resource (e.g., the value of selling carbon credits) from the cost of using the second resource and compare that cost with the cost of using the first resource to determine which resource is more economical to use. And, as discussed above, if the cost of using the first resource (i.e., diesel) is still lower than the cost of using the second resource (i.e., electricity) during on-peak hours (e.g., $0.21 for diesel versus $0.25 on-peak for electricity), the a user will still elect to utilize the second resource (electricity) during off-peak hours and utilize the first resource (diesel fuel) during on-peak hours. Considering those additional factors provides an even more accurate determination of which resource is most economical to use in a system.

In addition, certain resources may not be needed at the time they are most cost effective to utilize (e.g., on-peak versus off-peak times). Moreover, resource converters and resource consumers may have a more efficient load profile at levels of operation above or below that required to generate the desired amount of useful work. Accordingly, the resource storage devices (e.g., hot water storage) of the present invention are provided for collecting and storing various resources for future use during times of greater efficiency. That functionality allows the present invention to load level resource converters and resource consumers and to minimize or defer the use of a resource for cost benefit or availability reasons. For example, the present invention can help load level by analyzing whether a resource converter (e.g., a diesel generator) should be used to generate a consumable resource (e.g., electricity) at times other than those times of peak load requirements so that the consumable resource can be stored in a resource storage device (e.g., a battery system) for subsequent use when the resource converter would otherwise be operating at peak load. And, the present invention can account for resource cost and availability, for example, by using a resource (e.g., electricity) to perform a desired amount of useful work (e.g., to heat water) at times when the resource is less expensive to use (e.g., off-peak hours) and then storing that useful work in a resource storage device (e.g., hot water storage) so the useful work can then be used by a resource consumer (e.g., a shower) for its intended purpose (e.g., warm potable water) at times when the resource would be more expensive to use (e.g., on-peak hours). To facilitate load leveling and resource optimization as described, the present invention may monitor the costs of certain resources in real time to ensure the accuracy of the determination of which resources to utilize at which times. Resource storage may also be used to store useful waste energy (e.g., heat energy) gathered from various waste streams for subsequent use in the system.

Factors such as the purchase, installation, and maintenance costs of resource converters, resource consumers, and storage devices may also be taken into account by the present invention. Maintenance costs also include the costs associated with other resources consumed by a resource converter, resource consumer, or storage device (e.g., lubricating oils, fittings, etc.). In that way, the overhead costs associated with converting, consuming, or storing each resource may also be taken into account when determining which resource utilize to generate the desired amount of useful work. For example, the amortized cost of a specific resource converter can be assigned to specific periods of use and ownership and associated with the cost of using, or not using, that resource converter to convert a specific resource. Considering those details adds yet another level of accuracy to the analysis performed by the present invention.

It will be understood that other factors for each resource, resource converter, resource consumer, and resource storage device may also be considered to further improve the accuracy of the analysis, such as the effect of weather conditions on their performance/efficiency, their reliability, and the logistics associated with their use. In addition, the present invention can use all of those factors to compare the resources, resource converters, resource consumers, and storage devices in a system with any associated new technology and make a determination as to whether the system would be more efficient if a new technology were substituted into the system (e.g., a more efficient diesel generator that becomes available). Accordingly, the present invention can be used to select the most effective equipment upgrades, operational procedures, maintenance procedures, and repair and logistics choices that provide the best value for cost, reliability, and/or emissions over the life of a system.

The present invention can be configured to analyze substantially any type of system (e.g., a vessel, a building, an industrial facility, a city, a region, etc.) that includes any number and combination of resources (e.g., diesel fuel, kerosene, wind energy, hydraulic energy, solar energy, electricity, etc.), resource converters (e.g., engines, generators, turbines, solar panels, fuel cells, etc.), resource consumers (e.g., light bulbs, HVAC units, electrical appliances, mechanical devices, crank shafts, etc.), and resource storage (e.g., ice storage, hot water storage, chill water storage, water towers, compressed air storage, capacitors, battery systems, etc.). And, because the present invention is assembled in a modular fashion, multiple resources, resource converters, resource consumers, resource storage devices, and types of useful work accomplished can be added or removed to or from a module as required to model individual and/or groups of systems, including subsystems and tiers of system sets. As described above, the various modules are interconnected so the present invention can determine the appropriate ECMs to take by holistically analyzing the interrelations between each of the resources, resource converters, resource consumers, resource storage devices, and types of useful work accomplished. Moreover, interconnecting all the modules also allows the present invention to provide a complete financial understanding of how various financial variables (e.g., ROI, NPV, escalation energy rate, payback period, etc.) effect each other and allows multiple scenarios to be easily and quickly evaluated in reference tables.

The foregoing description and drawings should be considered as illustrative only of the principles of the invention. The invention may be configured in a variety of shapes and sizes and is not intended to be limited by the preferred embodiment. Numerous applications of the invention will readily occur to those skilled in the art. Therefore, it is not desired to limit the invention to the specific examples disclosed or the exact construction and operation shown and described. Rather, all suitable modifications and equivalents may be resorted to, falling within the scope of the invention.

What is claimed is:

1. A system for quantifying and optimizing resource consumption and waste generation of a plurality of resource consumer devices that consume one or more consumable resources to produce useful work, the system comprising:
an input module that receives input data related to each of the plurality of resource consumer devices and each of the one or more consumable resources;
a resource consumer module that determines an amount of the one or more consumable resource consumed by each of the plurality of resource consumer devices under a particular load and an amount of waste produced by each of the plurality of resource consumer devices under the particular load based at least in part on the input data;
a waste stream module that normalizes and sums the amount of waste produced by each of the plurality of resource consumer devices per amount of useful work produced; and
an output module that determines costs associated with operating the plurality of resource consumer devices based at least in part on the amount of the one or more consumable resource consumed by each of the plurality of resource consumer devices and the normalized and summed amount of waste produced by each of the plurality of resource consumer devices.

2. The system of claim 1, further comprising
one or more resource converter devices for converting one or more convertible resource into at least one of the one ore more consumable resources; and
a resource converter module that determines an amount of the at least one convertible resource converted into the at least one consumable resource by the one or more resource converter devices and an amount of waste produced by the one or more resource converter devices based at least in part on the input data,
wherein the waste stream module normalizes and sums the amount of waste produced by each of the one or more resource consumer devices per amount of consumable resource produced, and
wherein the output module determines costs associated with operating the one or more resource consumer devices based at least in part on the amount of the one or more convertible resource converted by each of the one or more resource consumer devices and the normalized and summed amount of waste produced by each of the one or more resource consumer devices.

3. The system of claim 1, further comprising
one or more resource storage devices for storing one or more consumable resources to provide one or more stored resources for later consumption by at least one of the plurality of resource consumer devices; and
a resource storage module that determines when at least one of the plurality of resource consumer devices will consume the one or more stored resources for at least one of leveling the particular load on at least one of the plurality of resource consumer devices and deferring when at least one of the plurality of resource consumer devices will consume the one or more stored resources to a later time based at least in part on the input data.

4. The system of claim 1, wherein
the waste stream module further determines an amount of useful waste that can be recaptured from the amount of waste produced by each of the plurality of resource consumer devices for at least one of being consumed by at least one of the plurality of resource consumer devices and reducing the particular load on at least one of the plurality of resource consumer devices is under.

5. The system of claim 4, wherein
the output module determines the costs associated with operating the plurality of resource consumer devices based at least in part on the amount of useful waste that can be recaptured for at least one of being consumed by at least one of the plurality of resource consumer devices and reducing the particular load on at least one of the plurality of resource consumer devices is under.

6. The system of claim 5, wherein
the output module determines the costs associated with operating the plurality of resource consumer devices based at least in part on the amount of useful waste that can be recaptured for reducing the particular load on at least one first resource consumer device is under and on the effect that the particular load on the least one first resource consumer device has on the particular load on at least one second resource consumer device.

7. The system of claim 1, wherein
the output module determines the costs associated with operating the plurality of resource consumer devices based at least in part on the effect that the particular load on at least one first resource consumer device has on the particular load on at least one second resource consumer device.

8. The system of claim 1, wherein
the output module determines the costs associated with operating the plurality of resource consumer devices based at least in part on an initial cost of each resource consumer device, cost of each consumable consumed by each resource consumer device, costs for disposing of the amounts of waste produced by each resource consumer device, and maintenance and repair costs over a give life cycle for each resource consumer device.

9. The system of claim 1, wherein
the output module adds the costs associated with operating the plurality of resource consumer devices of a first system with the costs associated with operating the plurality of resource consumer devices of at least a second system to provide costs associated with operating an assembly comprising the first system and the at least second system.

10. The system of claim 1, wherein
the output module determines the costs associated with operating the plurality of resource consumer devices based at least in part on input date corresponding to an existing condition of the system as well as the costs associated with operating the plurality of resource consumer devices based at least in part on input data corresponding to at least one proposed condition for resource conservation in the system.

11. The system of claim 1, wherein
the input data can be varied to perform a sensitivity analysis of the system based on the costs associated with operating the plurality of resource consumer devices for each variation of the input data.

12. The system of claim 1, wherein
the output module generates a report having at least one integral table that contains values representing at least the amount of the at least one consumable resource consumed by the plurality of resource consumer devices, the summed and normalized amount of waste produced by the plurality of resource consumer devices, amounts of useful work produced by the plurality of resource consumer devices, and the costs associated with operating the plurality of resource consumer devices.

13. The system of claim 1, wherein
the input module, the resource consumer module, the waste stream module, and the output module are operated by a processor.

14. The system of claim 1, wherein
the input module receives at least a portion of the input data from a user at an input device.

15. The system of claim 1, wherein
the output module outputs the costs associated with operating the system at a user interface.

16. A method for quantifying and optimizing resource consumption and waste generation for a plurality of resource consumer devices that consume one or more consumable resources to produce useful work, the method comprising the steps of:
receiving input data via an input device, the input data related to each of the plurality of resource consumer devices and each of the one or more consumable resources;
determining an amount of the one or more consumable resource consumed by each of the plurality of resource consumer devices under a particular load and an amount of waste produced by each of the plurality of resource consumer devices under the particular load with a processor based at least in part on the input data;
normalizing and summing the amount of waste produced by each of the plurality of resource consumer devices per amount of useful work produced with the processor;
determining costs associated with operating the plurality of resource consumer devices with the processor based at least in part on the amount of the one or more consumable resource consumed by each of the plurality of resource consumer devices and the normalized and summed amount of waste produced by each of the plurality of resource consumer devices; and
displaying the costs associated with operating the plurality of resource consumer devices at a user interface.

17. The method of claim 16, further comprising the steps of
providing one or more resource converter devices for converting one or more convertible resource into at least one of the one ore more consumable resources;
determining an amount of the at least one convertible resource converted into the at least one consumable resource by the one or more resource converter devices and an amount of waste produced by the one or more resource converter devices with the processor based at least in part on the input data;
normalizing and summing the amount of waste produced by each of the one or more resource consumer devices per amount of consumable resource produced with the processor;
determining costs associated with operating the one or more resource consumer devices with the processor based at least in part on the amount of the one or more convertible resource converted by each of the one or more resource consumer devices and the normalized and summed amount of waste produced by each of the one or more resource consumer devices; and
displaying the costs associated with operating the one or more resource consumer devices at the user interface.

18. The method of claim 16, further comprising the steps of
providing one or more resource storage devices for storing one or more consumable resources as one or more stored resources for later consumption by at least one of the plurality of resource consumer devices; and
determining with the processor when at least one of the plurality of resource consumer devices will consume the one or more stored resources for at least one of leveling the particular load on at least one of the plurality of resource consumer devices and deferring when at least one of the plurality of resource consumer devices will consume the one or more stored resources to a later time based at least in part on the input data.

19. The method of claim 16, further comprising the step of
determining with the processor an amount of useful waste that can be recaptured from the amount of waste produced by each of the plurality of resource consumer devices for at least one of being consumed by at least one of the plurality of resource consumer devices and reducing the particular load on at least one of the plurality of resource consumer devices is under.

20. The method of claim 19, wherein
the step of determining the costs associated with operating the plurality of resource consumer devices is based at least in part on the amount of useful waste that can be recaptured for at least one of being consumed by at least one of the plurality of resource consumer devices and reducing the particular load on at least one of the plurality of resource consumer devices is under.

21. The method of claim 20, wherein
the step of determining the costs associated with operating the plurality of resource consumer devices is based at least in part on the amount of useful waste that can be recaptured for reducing the particular load on at least one first resource consumer device is under and on the effect that the particular load on the least one first resource consumer device has on the particular load on at least one second resource consumer device.

22. The method of claim 16, wherein
the step of determining the costs associated with operating the plurality of resource consumer devices is based at least in part on the effect that the particular load on at least one first resource consumer device has on the particular load on at least one second resource consumer device.

23. The method of claim 16, wherein
the step of determining the costs associated with operating the plurality of resource consumer devices is based at least in part on an initial cost of each resource consumer device, cost of each consumable consumed by each resource consumer device, costs for disposing of the amounts of waste produced by each resource consumer device, and maintenance and repair costs over a give life cycle for each resource consumer device.

24. The method of claim 16, further comprising the steps of
repeating the method of claim 16 for a plurality of systems;
adding the costs associated with operating the plurality of resource consumer devices for each of the plurality of systems with the processor; and
displaying the costs associated with operating the plurality of resource consumer devices for each of the plurality of systems at a user interface.

25. The method of claim 16, wherein
the step of determining the costs associated with operating the plurality of resource consumer devices is based at least in part on input date corresponding to an existing condition of the system and is repeated based at least in part on input data corresponding to at least one proposed condition for resource conservation in the system.

26. The method of claim 16, further comprising the step of
performing a sensitivity analysis of the system based on the costs associated with operating the plurality of resource consumer by varying the input data and repeating each of the steps.
